(19) United States
(12) Patent Application Publication
(10) Pub. No.: US 2024/0043770 A1
(43) Pub. Date: Feb. 8, 2024

(54) A SYNERGISTIC PERFUMING COMPOSITION

(71) Applicant: Firmenich SA, Satigny (CH)

(72) Inventors: Sabine VON TSCHARNER, Plainsboro, NJ (US); Mark HAWARD, Plainsboro, NJ (US); Gerardo ENRIQUEZ ANDRADE, Plainsboro, NJ (US); Robert KNAB, Plainsboro, NJ (US)

(21) Appl. No.: 18/258,084

(22) PCT Filed: Dec. 16, 2021
(86) PCT No.: PCT/EP2021/086256

§ 371 Date: Jun. 16, 2023

Related U.S. Application Data
(60) Provisional application No. 63/127,252, filed on Dec. 18, 2020.

(30) Foreign Application Priority Data
Feb. 5, 2021 (EP) 21155615.4

(51) Int. Cl. C11B 9/00; A61Q 5/02; A61Q 5/12; A61Q 5/06; A61Q 15/00; A61Q 19/00; A61Q 19/10; C11D 3/50; C11D 3/00; C11D 17/06; C11D 3/20; C11D 3/382; C11D 3/26

(52) U.S. Cl. CPC C11B 9/0003; A61Q 5/02; A61Q 5/12; A61Q 5/06; A61Q 15/00; A61Q 19/00; A61Q 19/10; C11B 9/0015; C11B 9/0076; C11B 9/0061; C11B 9/0019; C11B 9/0023; C11D 3/50; C11D 3/001; C11D 17/06; C11D 3/2072; C11D 3/2096; C11D 3/2093; C11D 3/382; C11D 3/26

(57) ABSTRACT

The present invention relates to the field of perfumery. More particularly, it concerns perfuming composition comprising at least one profragrance and at least one perfuming ingredient having a LogP above 3. Following what is mentioned herein, the invention's 5 perfuming composition as a part of a perfuming composition or a perfumed consumer product and the use of the invention's perfuming composition are also objects of the invention.

### TECHNICAL FIELD

The present invention relates to the field of perfumery. More particularly, it concerns perfuming composition comprising at least one profragrance and at least one perfuming ingredient, having a LogP above 3. Following what is mentioned herein, the invention's perfuming composition as a part of a perfuming composition or a perfumed consumer product and the use of the invention's perfuming composition are also objects of the invention.

### BACKGROUND OF THE INVENTION

The perfume industry has a particular interest for compositions or additives which are capable of prolonging or enhancing the perfuming effect for a certain period of time. It is particularly desirable to obtain long-lasting properties in order to enhance the consumer experience. Long-lasting perfumes are desirable for various applications, as for example fine or functional perfumery or cosmetic preparations. The washing and softening of textiles are particular fields in which there is a constant need to enable the effect of active substances, in particular perfumes, or perfuming compositions, to be effective for a certain period of time after washing, softening and drying. Indeed, many active substances which are particularly suitable for this type of application are known to lack tenacity on laundry, or do not remain on the laundry when rinsed, with the result that their perfuming effect is experienced only briefly and not very intensely. Given the importance of this type of application in the perfume industry, research in this field has been sustained, in particular with the aim of finding new, and more effective solutions to the aforementioned problems.

Delivery systems have been developed in this regards such as microcapsules comprising in their core a perfume being released in a control manner. Microcapsules are particularly relevant to provide the highly sought long lasting perfuming effect leading to benefit from the perfume even after several days.

As an alternative to encapsulation systems, a variety of precursor compounds, also called profragrances or properfumes, which release active material by a chemical reaction during or after application (using O₂, light, enzymes, water (pH) or temperature as the release trigger) have been described. However, said precursors, even if they contribute to the slow release of the perfume, do not reach the long lasting effect provided by the microcapsules.

So, there is still a need to develop a system able to deliver a long lasting perfuming effect up to several days using profragrance compounds.

It has now been surprisingly found that a perfuming composition comprising at least one profragrance and at least one perfumery ingredient having a LogP above 3 solves the above-mentioned problem.

### DESCRIPTION OF THE INVENTION

It has now been discovered that a perfuming composition of matter comprising at least one profragrance compound and at least one perfuming ingredient having a LogP above 3 provides a long lasting effect of several days even a month equal or even better compared to microcapsules while providing an impact directly after use.

So a first object of the present invention is a perfuming composition of matter comprising
a) at least one profragrance compound;
b) at least one perfuming ingredient having a LogP above 3.

By the term “LogP”, it is meant the normal meaning in the art; i.e. the common logarithm of estimated octanol-water partition coefficient, which is known as a measure of lipophilicity. The LogP values of many perfuming compound have been reported, for example, in the Pomona92 database, available from Daylight. Chemical Information Systems, Inc. (Daylight CIS), Irvine, Calif., which also contains citations to the original literature. LogP values are most conveniently calculated by the “CLOGP” program, also available from Daylight CIS. This program also lists experimental logP values when they are available in the Pomona92 database. The “calculated LogP” (cLogP) is determined by the fragment approach of Hansch and Leo (cf., A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume oil ingredient, and takes into account the numbers and types of atoms, the atom connectivity, and chemical bonding. The cLogP values, which are the most reliable and widely used estimates for this physicochemical property, are preferably used instead of the experimental LogP values in the selection of perfuming compounds which are useful in the present invention.

Under a “perfuming composition” is to be understood a composition that is able to impart a hedonic effect to e.g. a consumer product. In other words, a composition to be considered as being a perfuming composition must be recognized by a skilled person in the art of perfumery as being able to impart, or modify the olfactory perception in a positive or pleasant way, and not just as imparting an odor.

According to the present invention, the perfuming composition of matter comprises at least one profragrance compound.

A “properfume” or “profragrance” is a compound that is able to release one, two or more perfume compounds, also termed PRMs (perfumery raw materials), upon external influence in a way that prolongs the perfuming effect of the PRMs. The PRMs are released from the properfume by the cleavage of a covalent bond by exposure to light, air/oxygen, heat, moisture or enzymes, or combinations thereof, as an external trigger or stimulus. Typically, the profragrance itself has a low volatility, and is ideally (almost) odorless. In the present invention, the terms “properfume” or “profragrance” are used indifferently. The pro-perfume may be advantageously characterized by a vapor pressure below 0.01 Pa, as obtained by calculation using the software EPlwin v. 3.10 (2000, available at the US Environmental Protection Agency). According to one embodiment, the vapor pressure is below 0.001 Pa. The pro-perfume may also be advantageously characterized by a molecular weight above 270, even above 300, even above 350. The terms “pro-perfume” or “pro-fragrance” have the normal meaning in the art as for example reported in A. Herrmann, Angew. Chem. Int. Ed., 2007, 46, 5836-5863.

In a particular embodiment, The perfuming ingredient released by the pro-perfume compounds used in the invention's composition may impart an additional benefit beyond that of modifying or imparting an odor, such as long-lasting, blooming, malodour counteraction, antimicrobial effect, antiviral effect, microbial stability, pest, control.

A “perfume compound”, “perfuming ingredient “or “perfumery raw material” (PRM) is a compound, which is used as an active ingredient in perfuming preparations or compositions in order to impart a hedonic effect. In other words, a compound to be considered as being a perfuming ingredient must be recognized by a skilled person in the art of perfumery as being able to impart or modify in a positive or pleasant way the odor of a composition, and not just as having an odor.

The perfuming composition according to the present invention can comprise at least one profragrance compound that release PRMs upon exposure to light.

By “light”, any form of electromagnetic radiation is meant, which is not limited to any particular wavelength. The release of PRMs from such pro-perfumes is usually more effective at lower wavelengths (higher energy input).

The perfuming composition according to the present invention can comprise at least one profragrance compound that release PRMs upon exposure to air/oxygen.

Thereby, the PRMs may be released from such pro-perfumes by oxidation in the presence of air (ambient air) or oxygen, preferably ambient air.

For the sake of clarity, by the expression “ambient air”, or the similar, it, is meant the normal meaning understood by a person skilled in the art, i.e. The oxidation occurs at room temperature, under air and atmospheric pressure. In other words, the environment wherein the compound is oxidized is air. Herewith it is understood, that the pro-perfume is oxidized in ambient air. In particular, it is understood that pro-perfume does not necessarily require a pure oxygen environment, heat or catalyst to be oxidized.

The perfuming composition of matter according to the present invention can comprise at least one profragrance compound that release PRMs upon exposure to heat.

By “heat”, it, is meant, any energy input that is caused by increased temperature. The temperature to be applied is not limited to a particular temperature range, but rather depends on the individual pro-perfume. It lies within the knowledge of a skilled person to determine appropriate temperatures.

The perfuming composition of matter according to the present invention can comprise at least one profragrance compound that release PRMs upon exposure to moisture.

Such pro-perfumes may show chemical bonds that are susceptible to water-induced cleavage, and may thus be cleaved in the presence of water.

The perfuming composition of matter according to the present invention can comprise at least one profragrance compound that release PRMs upon exposure to enzymes.

Such pro-perfumes may show chemical bonds that can efficiently be cleaved in the presence of enzymes. It lies within the knowledge of a skilled person to determine which chemicals bonds can effectively be cleaved by a certain type of enzyme.

In some cases, pro-perfumes may exist that are prompted to release perfumery raw materials not only based on one type of mechanism as mentioned above, but based on one or more of the types mentioned above simultaneously or independently from each other. However, for every pro-perfume there exists one or two types of release mechanism that are particularly efficient or superior to other types that may theoretically be envisaged. If not anyway mentioned within the context of the present invention, it lies well within the knowledge of a skilled person to determine the main types of release mechanism for existing pro-perfumes.

According to any embodiments of the invention, the at least one profragrance compound releases a perfume raw material upon exposure to air/oxygen or enzymes.

In a particular embodiment, the perfuming composition comprises 1 to 5 or even more pro-perfume compounds, preferably 1 to 3 pro-perfume compounds, even more preferably 1 to 2 pro-perfume compounds.

According to a particular embodiment, the at least one profragrance may be a sulfur containing profragrance.

According to a particular embodiment, the at least one profragrance compounds to be used according to the present invention is a compound of formula

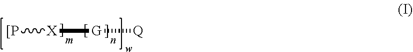

Wherein:
a) w represents an integer from 1 to 10000;
b) n represents 1 or 0;
c) m represents an integer from 1 to 6;
d) P represents a hydrogen atom or a radical susceptible of generating an odoriferous α,β-unsaturated ketone, aldehyde or carboxylic ester and is represented by the formula

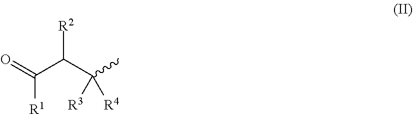

In which the wavy line indicates the location of the bond between said P and X; R¹ represents a hydrogen atom, a C₁ to C₆ alkoxyl radical or a C₁ to C₁₅ linear, cyclic or branched alkyl, alkenyl or alkadienyl radical, optionally substituted by one to four C₁ to C₄ alkyl groups; and

R², R³ and R⁴ represent independently of each other a hydrogen atom, an aromatic ring, or a C₁ to C₁₅ linear, cyclic or branched alkyl, alkenyl or alkadienyl radical, possibly substituted by C₁ to C₄ alkyl groups; or two, or three, of the groups R¹ to R⁴ are bonded together to form a saturated or unsaturated ring having 5 to 20 carbon atoms and including the carbon atom to which said R¹, R², R³ or R⁴ groups are bonded, this ring being possibly substituted by C₁ to C₈ linear, branched or cyclic alkyl or alkenyl groups; and with the proviso that, at least, one of the P groups is of the formula (II) as defined hereinabove;
e) X represents, independently from each other, a functional group selected from the group consisting of the formulae i) to xiv):

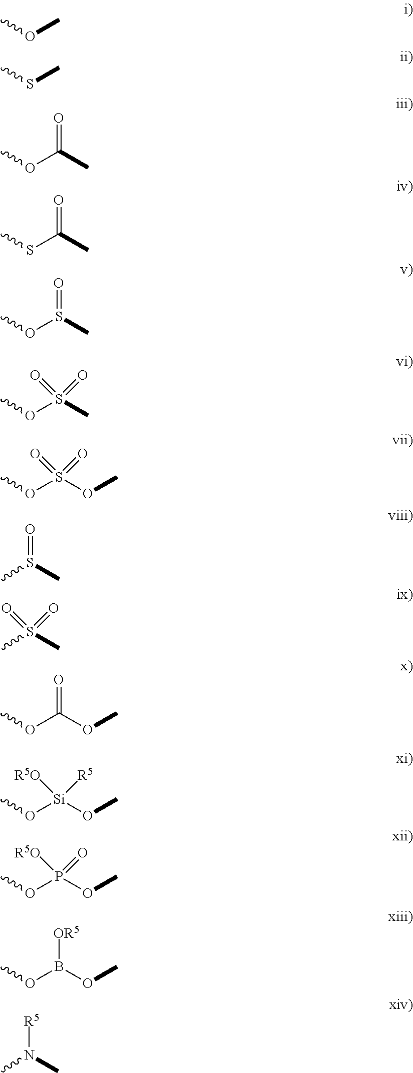

In which formulae the wavy lines are as defined previously and the bold lines indicate the location of the bond between said X and G, and R⁵ represents a hydrogen atom, a C₁ to C₂₂, saturated or unsaturated, alkyl group or an aryl group, possibly substituted by C₁ to C₆ alkyl or alkoxyl groups or halogen atoms; and with the proviso that X may not exist when P represents a hydrogen atom;
f) G represents a multivalent radical (with a m+1 valence) derived from cyclic, linear, alicyclic or branched alkyl, cyclic, linear, alicyclic or branched alkenyl, phenyl, alkylphenyl or alkenylphenyl hydrocarbon radical having from 1 to 22 carbon atoms, said hydrocarbon radical being possibly substituted and containing from 1 to 10 functional groups selected from the group consisting of halogens, alcohols, ethers, esters, ketones, aldehydes, carboxylic acids, thiols, thioethers, amines, quaternary amines and amides; and
g) Q represents a hydrogen atom (in which case w=1 and n=1), or represents a polymer or co-polymer selected from the group consisting of poly(alkylimine)s, polypeptides (e.g. Polylysine) or polysaccharides selected from the group consisting of cellulose, cyclodextrins and starches, or cationic quaternized silicon polymers, or still a polymer or random co-polymer derived from monomeric units selected from the group consisting of the formulae A-1), A-2), A-3), B-1), B-2), C-1). C-2), and C-3):

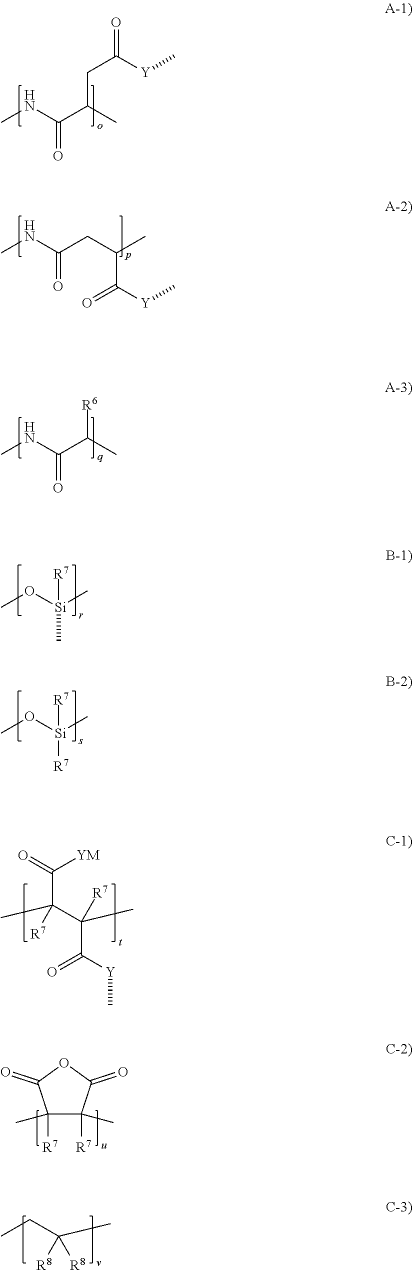

Wherein the hatched lines indicate the location of the bond between said monomeric unit and G;
Y represents an oxygen or sulfur atom or a NR⁷ group;
O, p, q, r, s, t, u and v all represent independent of each other fractions between 0 and 1, with o+p+q=1, r+s=1 and t+u+v=1 and with the proviso that either o or p, as well as r and t are not equal to 0;
R⁶ represents a hydrogen atom or a side chain from a natural or unnatural amino acid, such as glycine, alanine, phenylalanine, arginine, histidine, lysine, aspartic acid, glutamic acid, cysteine, methionine, glutamine, asparagine, threonine, serine, leucine, isoleucine, valine, tyrosine or tryptophan;
R⁷ represents, simultaneously or independently, a hydrogen atom or a C₁-C₁₆ hydrocarbon group;
R⁸ represents, simultaneously or independently of each other
   a hydrogen or halide atom;
   a C₁-C₆ hydrocarbon group optionally comprising from 1 to 4 heteroatoms selected from the group consisting of oxygen and sulfur atoms;
   a carboxylic group of formula COOR*, wherein R* represents a hydrogen atom, a C₁-C₆₀ alkyl or alkenyl group optionally comprising from 1 to 30 oxygen atoms;
   a OR⁷ group or a COR⁷ group; or
   a pyrrolidone unit, connected by the nitrogen atom; and
M represents a hydrogen atom, an alkali or earth alkali metal ion.

In a particular embodiment, X represents a functional group selected from the group consisting of the formulae ii), iii), viii), ix) and xiv). In a particular embodiment, X represents the functional group of formula ii).

As “odoriferous α,β-unsaturated ketone, aldehyde or carboxylic ester”, the expression used in the definition of P, it is understood an α,β-unsaturated ketone, aldehyde or carboxylic ester, which is recognized by a skilled person as being used in perfumery as perfuming ingredient. In general, said odoriferous α,β-unsaturated ketone, aldehyde or carboxylic ester is a compound having from 8 to 20 carbon atoms, or even more preferably between 10 and 15 carbon atoms.

Similarly, it is not possible to provide an exhaustive list of the currently known odoriferous compounds, which can be used in the synthesis of the invention compounds defined hereinabove and subsequently be released. However, the following can be named as preferred examples: alpha-damascone, beta-damascone, gamma-damascone, delta-damascone. 1-[6-ethyl-2,6-dimethyl-3-cyclohexen-1-yl]-2-buten-1-one, alpha-ionone, beta-ionone, gamma-ionone, delta-ionone, beta-damascenone, 2-methyl-1-(2,6,6-trimethylcyclohex-3-en-1-yl)but-2-en-1-one, 3-methyl-5-propyl-2-cyclohexen-1-one, 2-methyl-5-(1-propen-2-yl)-2-cyclohexen-1-one, 2,5-dimethyl-5-phenyl-1-hexen-3-one, 1-(5,5-dimethyl-1-cyclohexen-1-yl)-4-penten-1-one, 3,7-dimethylocta-2,6-dienal, 8-methyl-alpha-ionone or 10-methyl-alpha-ionone, 2-octenal, 1-(2,2,3,6-tetramethylcyclohexyl)but-2-en-1-one, 4-(2,2,3,6-tetramethylcyclohexyl)but-3-en-2-one, 2-cyclopentadecen-1-one, 4,4a-dimethyl-6-(1-propen-2-yl)-4,4a,5,6,7,8-hexahydro-2(3H)-naphthalenone. (E)-3-phenylprop-2-enal (cinnamic aldehyde), 2,6,6-trimethylspiro[bicyclo[3.1.1]heptane-3,1′-cyclohexan]-2′-en-4′-one, ethyl 2,4-deca-dienoate, ethyl 2-octenoate, methyl 2-nonenoate, ethyl 2,4-undecadienoate, 4-methylpent-3-en-2-one, oct-2-en-4-one, and methyl 5,9-dimethyl-2,4,8-decatrienoate.

In a particular embodiment, P represents a radical selected from the group consisting of formulae (P-1) to (P-14), in the form of any one of its isomers:

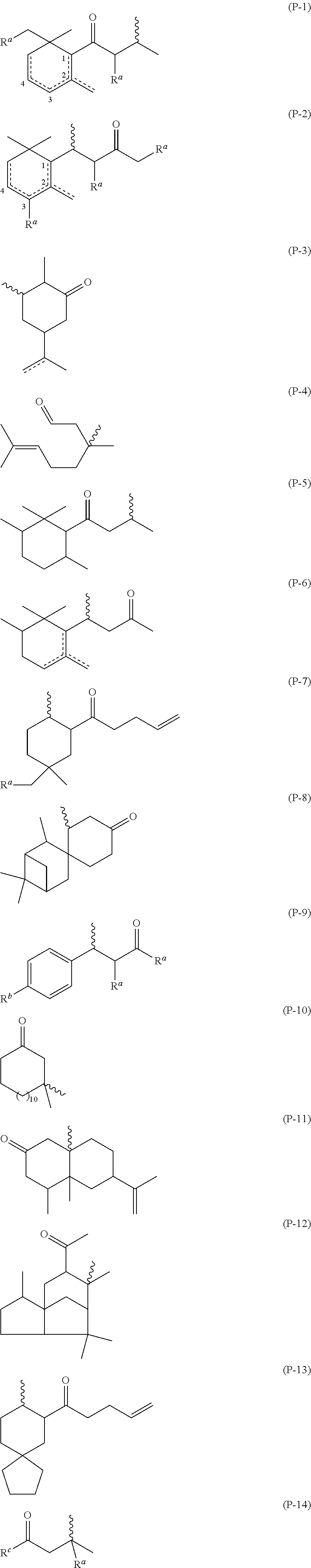

in which formulae the wavy lines have the meaning indicated above and the dotted lines represent a single or double bond, R^{a} being a hydrogen atom or a methyl group, R^{b} representing a hydrogen atom, a hydroxyl or methoxy group or a C₁-C₄ linear or branched alkyl group and R^{c} representing a hydrogen atom or a C₁-C₄ linear or branched alkyl group.

In a particular embodiment, P represents a radical selected from the group consisting of formulae

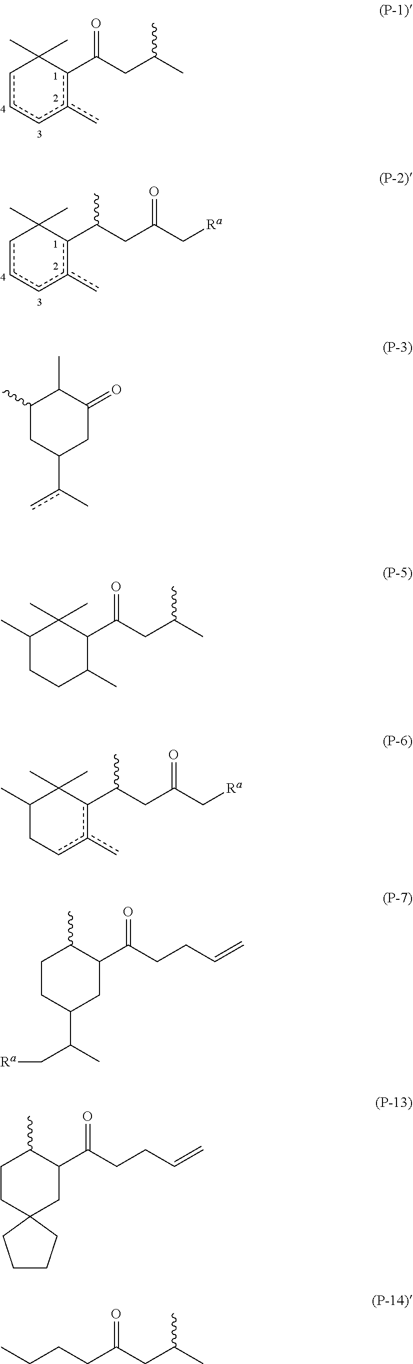

Wherein the wavy lines have the meaning indicated above and the dotted lines represent a single or double bond, and R^{a} being a hydrogen atom or a methyl group.

In a particular embodiment, P represents a radical selected from the group consisting of formulae (P-1), (P-2), (P-1)′, (P-2)′, (P-3), (P-7), (P-13), (P-14) or (P-14)′ as defined above. Preferably, P represents a radical selected from the group consisting of formulae (P-1), (P-1)′, (P-2), (P-2)′, (P-3) or (P-14)′ as defined above.

In a particular embodiment, G may represent a divalent cyclic, linear, acyclic or branched alkyl, alkenyl, alkandienyl or alkylbenzene hydrocarbon radical having from 1 to 22 carbon atoms, said hydrocarbon radical being possibly substituted and containing from 1 to 10 functional groups selected from the group consisting of ethers, esters, ketones, aldehydes, carboxylic acids, thiols, thioethers, amines, quaternary amines and amides.

In a particular embodiment, G represents a divalent linear or branched alkyl or alkenyl hydrocarbon radical having from 1 to 22 carbon atoms, said hydrocarbon radical being possibly substituted and containing from 1 to 5 functional groups selected from the group consisting of ethers, esters, ketones, aldehydes, carboxylic acids, thiols, thioethers, amines, quaternary amines and amides.

In a particular embodiment, G represents a divalent linear or branched alkyl or alkenyl hydrocarbon radical having from 2 to 15 carbon atoms, said hydrocarbon radical being possibly substituted and containing from 1 to 2 functional groups selected from the group consisting of ethers and esters.

In a particular embodiment, G represents a divalent linear alkyl or alkenyl hydrocarbon radical having from 3 to 15 carbon atoms, said hydrocarbon radical being possibly substituted and containing ne ester functional group.

In a particular embodiment, G represents a divalent, linear alkyl or alkenyl hydrocarbon radical having from 3 to 14 carbon atoms.

In a particular embodiment, Q represents a hydrogen atom or a co-polymer comprising at least one repeating unit of formula B-1 as defined above.

In a particular embodiment, Q represents a hydrogen atom or a co-polymer comprising at least one repeating unit of formula B-1 and at least one repeating unit, of formula B-2.

In a particular embodiment, R⁷ represents, simultaneously or independently, a hydrogen atom or a C₁₋₃ alkyl group. Preferably, R⁷ represents, simultaneously or independently, a hydrogen atom or a methyl or an ethyl group. More preferably, R⁷ represents, simultaneously or independently, a hydrogen atom or a methyl group.

In a particular embodiment, the first pro-perfume compound is defined by formula (I) as mentioned above, wherein
w=1;n=1;m=1;
P represents a radical susceptible of generating an odoriferous α,β-unsaturated ketone, aldehyde and is represented by the formula

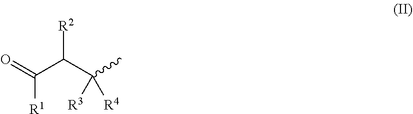

Wherein R², R³ and R⁴ represent independently of each other a hydrogen atom, a C₆ to C₁₀ aromatic ring, or a C₁ to C₁₅ linear, cyclic or branched alkyl, alkenyl or alkadienyl radical, possibly substituted by C₁ to C₄ alkyl groups; or two, or three, of the groups R¹ to R⁴ are bonded together to form a saturated or unsaturated ring having 5 to 20 carbon atoms and including the carbon atom to which said R¹, R², R³ or R⁴ groups are bonded, this ring being possibly substituted by C₁ to C₈ linear, branched or cyclic alkyl or alkenyl groups;
X represents formula ii)
G represents a divalent radical derived from cyclic, linear or branched alkyl, alkenyl, phenyl, alkylphenyl or alkenylphenyl hydrocarbon radical having from 2 to 8 carbon atoms optionally comprising 1 or 2 oxygen, sulfur and/or nitrogen atoms
Q represents a polymer or random co-polymer derived from formula B-1), wherein R⁷ represents a C₁-C₁₆ hydrocarbon group.

In a particular embodiment, the at least one profragrance compound may be a linear polysiloxane co-polymer comprising at least, one repeating unit of formula

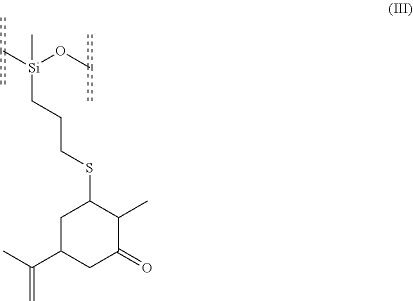

Wherein the double hatched lines indicate the bonding to another repeating unit.

The pro-perfume of formula (III) releases 2-methyl-5-(prop-1-en-2-yl)cyclohex-2-en-1-one as fragrance compound, which is also known as carvone. Carvone exists in the form of two enantiomers, namely (R)-(−)-2-methyl-5-(1-propen-2-yl)-2-cyclohexen-1-one (1-carvone or carvone laevo) and (S)-(+)-2-methyl-5-(1-propen-2-yl)-2-cyclohexen-1-one (d-carvone or carvone dextro). The two enantiomers have been reported to have slightly different mint odor tonalities. Nevertheless, according to the invention, both enantiomers are expected to have a similar effect in view of the preparation of the co-polymer and the release efficiency. According to the invention, carvone can either be used as a racemate or as a mixture enriched in either one of the two enantiomers. Preferably, a mixture enriched in carvone laevo is used.

In a particular embodiment, the sulfur-containing pro-perfume compound is of formula (IV)

P—S-G-Q (IV)
Wherein
P has the same meaning as defined above:
G represents a divalent radical derived from a linear or branched alkyl or alkenyl radical having from 2 to 15 carbon atoms, possibly substituted with one or more groups selected from the group consisting of —OR⁹, —NR⁹₂, —COOR⁹ and R⁹ groups, in which R⁹ represents a hydrogen atom or a C₁ to C₆ alkyl or alkenyl group; and
Q represents a hydrogen atom.

In a particular embodiment, the at least one profragrance compound may be a compound selected from the group consisting of formulae a) to d)

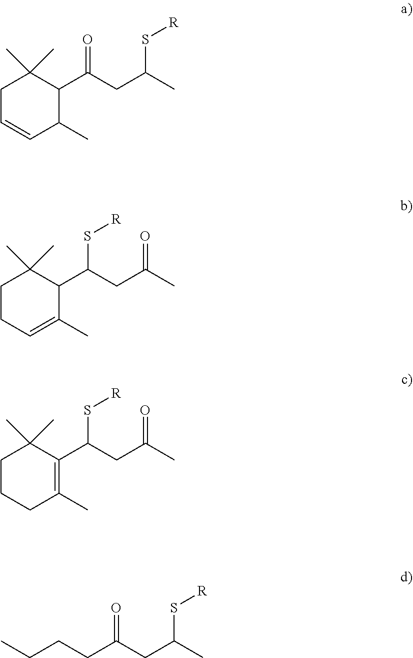

Wherein R represents a C₁-C₂₀ alkyl or alkenyl group, preferably a C₆-C₁₆ alkyl or alkenyl group, more preferably a C₁₂ alkyl group.

The profragrance compound of formula a) releases delta-damascone as fragrance compound. Said pro-perfume may preferably be (±)-trans-3-(dodecylthio)-1-(2,6,6-trimethyl-3-cyclohexen-1-yl)-1-butanone. Delta-damascone is also known as 1-[(1RS,2SR)-2,6,6-trimethyl-3-cyclohexen-1-yl]-2-buten-1-one.

The profragrance compound of formula b) or c) releases ionone as fragrance compound. Said pro-perfume may be present as an isomeric mixture of formula b) and formula c). The isomeric mixture may have a weight ratio of formula b) and formula c) from 40:60 to 60:40. In particular, the isomeric mixture may have a weight ratio of formula b) and formula c) of about 55:45. In particular, said pro-perfume releases two isomers of ionone as fragrance compound.

In particular, the profragrance compound of formula b) releases alpha-ionone as fragrance compound. Said pro-perfume of formula b) may preferably be (±)-4-(dodecylthio)-4-(2,6,6-trimethyl-2-cyclohexen-1-yl)-2-butanone. Alpha-ionone is also known as (±)-(3e)-4-(2,6,6-trimethyl-2-cyclohexen-1-yl)-3-buten-2-one.

In particular, the profragrance compound of formula c) releases beta-ionone as fragrance compound. Said pro-perfume of formula c) may preferably be (±)-4-(dodecylthio)-4-(2,6,6-trimethyl-1-cyclohexen-1-yl)-2-butanone. Beta-ionone is also known as (3E)-4-(2,6,6-trimethyl-1-cyclohexen-1-yl)-3-buten-2-one.

The profragrance compound of formula d) releases oct-2-en-4-one as fragrance compound. Said pro-perfume may preferably be (±)-2-(dodecylthio)octan-4-one. Oct-2-en-4-one may be released as its (E)- or (Z)-isomers, or as mixtures thereof, with the (E)-isomer being preferred.

According to a particular embodiment, the at least, one profragrance of formula (I) may be selected from the group consisting of methyl or ethyl 2-(4-oxo-4-(2,6,6-trimethylcyclohex-3-en-1-yl)butan-2-ylamino)-3-(4-oxo-4-(2,6,6-trimethylcyclohex-3-en-1-yl)butan-2-ylthio)propanate, methyl or ethyl 2-(4-oxo-4-(2,6,6-trimethylcyclohex-2-en-1-yl)butan-2-ylamino)-3-(4-oxo-4-(2,6,6-trimethylcyclohex-2-en-1-yl)butan-2-ylthio)propanate, methyl or ethyl 2-(2-oxo-4-(2,6,6-trimethylcyclohex-1-en-1-yl)butan-4-ylamino)-3-(2-oxo-4-(2,6,6-trimethylcyclohex-1-en-1-yl)butan-4-ylthio)propanate, methyl or ethyl 2-(2-oxo-4-(2,6,6-trimethylcyclohex-2-en-1-yl)butan-4-ylamino)-3-(2-oxo-4-(2,6,6-trimethylcyclohex-2-en-1-yl)butan-4-ylthio)propanate, 3-(dodecylthio)-1-(2,6,6-trimethylcyclohex-3-en-1-yl)-1-butanone, 3-(dodecylthio)-1-(2,6,6-trimethylcyclohex-2-en-1-yl)-1-butanone, 3-(dodecylsulfonyl)-1-(2,6,6-trimethylcyclohex-3-en-1-yl)butan-1-one, 4-(dodecylthio)-4-(2,6,6-trimethylcyclohex-2-en-1-yl)-2-butanone, 4-(dodecylthio)-4-(2,6,6-trimethylcyclohex-1-en-1-yl)-2-butanone, 2-dodecylsulfanyl-5-methyl-heptan-4-one, 2-cyclohexyl-1-dodecylsulfanyl-hept-6-en-3-one, 3-(dodecylthio)-5-isopropenyl-2-methylcyclohexanone, 2-(dodecylthio)-4-octanone, 2-(dodecylsulfonyl)octan-4-one, 4-(dodecylthio)-4-methylpentan-2-one, methyl or ethyl N,S-bis(4-oxo-4-(2,6,6-trimethylcyclohex-3-en-1-yl)butan-2-yl)-L-cysteinate, methyl or ethyl S-(4-oxo-4-(2,6,6-trimethylcyclohex-3-en-1-yl)butan-2-yl)-L-cysteinate, 4-oxooctan-2-yl dodecanoate, and any mixtures thereof. Preferably, the pro-perfume compound of formula (I) may be selected from the group consisting of 3-(dodecylthio)-1-(2,6,6-trimethylcyclohex-3-en-1-yl)butan-1-one (Haloscent® D), 3-(dodecylthio)-1-(2,6,6-trimethylcyclohex-2-en-1-yl)butan-1-one, 4-(dodecylthio)-4-(2,6,6-trimethylcyclohex-2-en-1-yl)butan-2-one (Haloscent® I) and 4-(dodecylthio)-4-(2,6,6-trimethylcyclohex-1-en-1-yl)butan-2-one (Haloscent® I), 2-(dodecylthio)-4-octanone, 2-(dodecylsulfonyl)octan-4-one, 4-(dodecylthio)-4-methylpentan-2-one, methyl or ethyl N,S-bis(4-oxo-4-(2,6,6-trimethylcyclohex-3-en-1-yl)butan-2-yl)-L-cysteinate, methyl or ethyl S-(4-oxo-4-(2,6,6-trimethylcyclohex-3-en-1-yl)butan-2-yl)-L-cysteinate, 4-oxooctan-2-yl dodecanoate and any mixtures thereof. Preferably, the pro-perfume compound of formula (I) may be 3-(dodecylthio)-1-(2,6,6-trimethylcyclohex-3-en-1-yl)butan-1-one (HaloScent® D), 4-(dodecylthio)-4-(2,6,6-trimethylcyclohex-2-en-1-yl)butan-2-one (HaloScent® I), 4-(dodecylthio)-4-(2,6,6-trimethylcyclohex-1-en-1-yl)butan-2-one (HaloScent® I), or a mixture thereof. Preferably, the pro-perfume compound of formula (I) may be a mixture of 3-(dodecylthio)-1-(2,6,6-trimethylcyclohex-3-en-1-yl)butan-1-one (HaloScent® D), 4-(dodecylthio)-4-(2,6,6-trimethylcyclohex-1-en-1-yl)butan-2-one (HaloScent® I) and 4-(dodecylthio)-4-(2,6,6-trimethylcyclohex-2-en-1-yl)butan-2-one (HaloScent® I).

According to another particular embodiment, the at least one profragrance to be used in the present invention may be a pro-perfume compound according to formula

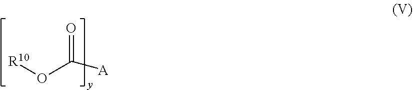

wherein
y is either 1 or 2,
A is an y-valent C₁₋₂₂ hydrocarbon group, and
R¹⁰ is derived from a C₆₋₂₀ perfuming alcohol of formula R¹⁰OH as defined above.

In a particular embodiment, the y-valent C₁₋₂₂ hydrocarbon group A in formula (V) is preferably derived from lauric acid, myristic acid, palmitic acid, stearic acid and oleic acid (for y=1) or from malonic acid, succinic acid, glutaric acid, adipic acid or sebacic acid (for y=2).

In a particular embodiment, preferred perfuming alcohols of formula R¹⁰OH comprise 2-hexenol, 3-hexenol, 3,7-dimethyl-6-octenol, 3,7-dimethyl-2,6-octadienol, 9-decen-1-ol, 3-methyl-5-phenylpentanol, 3,7,11-trimethyl-2,6,10-dodecatrienol, 2-ethyl-4-(2,2,3-trimethylcyclopent-3-enyl)but-2-enol, 4-(4-hydroxyphenyl)butan-2-one, 4-hydroxy-3-methoxybenzaldehyde, (2E,6Z)-2,6-nonadien-1-ol, 3-ethoxy-4-hydroxybenzaldehyde or 2-ethyl-3-hydroxy-4H-pyran-4-one.

In a particular embodiment, the at least one profragrance may be selected from the group consisting of 3-methyl-5-phenylpentyl palmitate, (2E)-3,7-dimethyl-2,6-octadien-1-yl-hexadecanoate (geranyl palmitate), (2E,6Z)-2,6-nonadien-1-yl palmitate, (2E,6Z)-2,6-nonadien-1-yl laurate, (2E,6Z)-2,6-nonadien-1-yl myristate and bis((2E)-3,7-dimethylocta-2,6-dien-1-yl) succinate (digeranyl succinate).

According to any embodiments of the invention, the at least one profragrance is selected from the group consisting of profragrance compound of formula (III) as defined above, 3-(dodecylthio)-1-(2,6,6-trimethylcyclohex-3-en-1-yl)butan-1-one (Haloscent® D), 2-(dodecylthio)-4-octanone, 2-(dodecylsulfonyl)octan-4-one, 3-(dodecylthio)-1-(2,6,6-trimethylcyclohex-2-en-1-yl)butan-1-one, 4-(dodecylthio)-4-(2,6,6-trimethylcyclohex-2-en-1-yl)butan-2-one (Haloscent® I) and 4-(dodecylthio)-4-(2,6,6-trimethylcyclohex-1-en-1-yl)butan-2-one (Haloscent® I), 4-oxooctan-2-yl dodecanoate, 2-phenylethyl oxo(phenyl)acetate, 3,7-dimethylocta-2,6-dien-1-yl oxo(phenyl)acetate, (Z)-hex-3-en-1-yl oxo(phenyl)acetate, 3,7-dimethyl-2,6-octadien-1-yl hexadecanoate, bis(3,7-dimethylocta-2,6-dien-1-yl) succinate, 3-methyl-5-phenylpentyl palmitate, (2-((2-methylundec-1-en-1-yl)oxy)ethyl)benzene, 1-methoxy-4-(3-methyl-4-phenethoxybut-3-en-1-yl)benzene, (3-methyl-4-phenethoxybut-3-en-1-yl)benzene, 1-(((Z)-hex-3-en-1-yl)oxy)-2-methylundec-1-ene, (2-((2-methylundec-1-en-1-yl)oxy)ethoxy)benzene, 2-methyl-1-(octan-3-yloxy)undec-1-ene, 1-methoxy-4-(1-phenethoxyprop-1-en-2-yl)benzene, 1-methyl-4-(1-phenethoxyprop-1-en-2-yl)benzene, 2-(1-phenethoxy prop-1-en-2-yl)naphthalene, (2-phenethoxyvinyl)benzene, 2-(1-((3,7-dimethyloct-6-en-1-yl)oxy)prop-1-en-2-yl)naphthalene, 4-allyl-2-methoxy-1-((2-methoxy-2-phenylvinyl)oxy)benzene, (2-((2-pentylcyclopentylidene)methoxy)ethyl)benzene, (2-((2-heptylcyclopentylidene)methoxy)ethyl)benzene, (2-((2-methyl-4-(2,6,6-trimethylcyclohex-1-en-1-yl)but-1-en-1-yl)oxy)ethyl)benzene, 1-methoxy-4-(1-phenethoxyprop-1-en-2-yl)benzene, 1-methoxy-4-(2-methyl-3-phenethoxyallyl)benzene, (2-((2-isopropyl-5-methylcyclohexylidene)methoxy)ethyl)benzene, 1-isopropyl-4-methyl-2-((2-pentylcyclopentylidene)methoxy)benzene, 2-methoxy-1-((2-methoxy-2-phenylvinyl)oxy)-4-propylbenzene, 2-ethoxy-1-((2-methoxy-2-phenylvinyl)oxy)-4-methylbenzene, 3-methoxy-4-((2-methoxy-2-phenylvinyl)oxy)benzaldehyde, 1-isopropyl-2-((2-methoxy-2-phenylvinyl)oxy)-4-methylbenzene, 4-((2-(hexyloxy)-2-phenylvinyl)oxy)-3-methoxybenzaldehyde and a mixture thereof. In particular, the invention's perfuming composition of matter comprises at least trans-3-(dodecylthio)-1-(2,6,6-trimethyl-3-cyclohexen-1-yl)-1-butanone and one or more profragrance compounds selected from the group of 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-butanone, profragrance compound of formula (III) as defined above, 2-(dodecylthio)octan-4-one, 2-phenylethyl oxo(phenyl)acetate, 3,7-dimethylocta-2,6-dien-1-yl oxo(phenyl)acetate, (Z)-hex-3-en-1-yl oxo(phenyl)acetate, 3,7-dimethyl-2,6-octadien-1-yl hexadecanoate, bis(3,7-dimethylocta-2,6-dien-1-yl) succinate, (2((2-methylundec-1-en-1-yl)oxy)ethyl)benzene, 1-methoxy-4-(3-methyl-4-phenethoxybut-3-en-1-yl)benzene, (3-methyl-4-phenethoxybut-3-en-1-yl)benzene, 1-(((Z)-hex-3-en-1-yl)oxy)-2-methylundec-1-ene, (2-((2-methylundec-1-en-1-yl)oxy)ethoxy)benzene, 2-methyl-1-(octan-3-yloxy)undec-1-ene, 1-methoxy-4-(1-phenethoxyprop-1-en-2-yl)benzene, 1-methyl-4-(1-phenethoxyprop-1-en-2-yl)benzene, 2-(1-phenethoxyprop-1-en-2-yl)naphthalene, (2-phenethoxyvinyl)benzene, 2-(1-((3,7-dimethyloct-6-en-1-yl)oxy)prop-1-en-2-yl)naphthalene, 1-(4-(((Z)-hex-3-en-1-yl)oxy)-3-methylbut-3-en-1-yl)-4-methoxybenzene, 4-allyl-2-methoxy-1-((2-methoxy-2-phenylvinyl)oxy)benzene, (2-((2-pentylcyclopentylidene)methoxy)ethyl)benzene, (2-((2-heptylcyclopentylidene)methoxy)ethyl)benzene, (2-((2-pentylcyclopentylidene)methoxy)ethyl)benzene, (2-((2-methyl-4-(2,6,6-trimethylcyclohex-1-en-1-yl)but-1-en-1-yl)oxy)ethyl)benzene, 1-methoxy-4-(1-phenethoxyprop-1-en-2-yl)benzene, 1-methoxy-4-(2-methyl-3-phenethoxyallyl)benzene, (2-((2-isopropyl-5-methylcyclohexylidene)methoxy)ethyl)benzene, 1-isopropyl-4-methyl-2-((2-pentylcyclopentylidene)methoxy)benzene, 2-methoxy-1-((2-methoxy-2-phenylvinyl)oxy)-4-propylbenzene, 2-ethoxy-1-((2-methoxy-2-phenylvinyl)oxy)-4-methylbenzene, 3-methoxy-4-((2-methoxy-2-phenylvinyl)oxy)benzaldehyde, 1-isopropyl-2-((2-methoxy-2-phenylvinyl)oxy)-4-methylbenzene or 4-allyl-2-methoxy-1-((2-methoxy-2-phenylvinyl)oxy)benzene. In particular, the invention's perfuming composition of matter comprises at least trans-3-(dodecylthio)-1-(2,6,6-trimethyl-3-cyclohexen-1-yl)-1-butanone and one or two profragrance compounds selected from the group of 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-butanone and profragrance compound of formula (III) as defined above.

In a particular embodiment, the invention's perfuming composition of matter comprises at least one profragrance compound in an amount of from 0.05 wt. % to 50 wt. %, preferably from 0.1 wt. % to 30 wt. %, preferably from 0.5 wt. % to 25 wt. %, preferably from 1 wt. % to 20 wt. % based on the total weight of the perfuming composition of matter.

According to any embodiments of the invention, the perfuming composition of matter comprises at least one perfuming ingredient having a LogP comprised in the range between 3 and 7.5, particularly, between 3 and 6.

According to any embodiments of the invention, the at least one perfuming ingredient having a LogP above 3 may be selected from the group consisting of 2-methyl-3-[4-(2-methyl-2-propanyl)phenyl[propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1.6}]undecan-7-one, tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0^{2,6}]dec-3-en-8-yl acetate, tricyclo[5.2.1.0(2,6)]dec-4-en-8-yl acetate, 1-((2RS,3RS)-2,3,8,8-tetramethyl-1,2,3,4,5,6,7,8-octahydronaphthalen-2-yl)ethanone, 1-[(2RS,3RS,8aRS)-2,3.8,8-tetramethyl-1,2,3,5,6,7,8.8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, 1-R1RS,2RS)-1,2,8,8-tetramethyl-1,2,3,4,5,6,7,8-octahydro-2-naphthalenyl]ethanone, 1-[(1RS,2RS,8aSR)-1,2,8,8-tetramethyl-1,2,3,5,6,7,8,8a-octahydro-2-naphthalenyl]ethenone, 1-(1,2,3,4,5,6,7,8-octahydro-2,3,8,8,-tetramethyl-2-naphthyl)ethan-1-one, (1-ethoxyethoxy)cyclododecane, (ethoxymethoxy)cyclododecane, cyclohexyl 2-hydroxybenzoate, 2-inethylbutyl salicylate, pentyl salicylate, 2-phenylethyl 2-hydroxybenzoate, hexyl 2-hydroxybenzoate, benzyl salicylate, cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, 1-oxa-12-cyclohexadecen-2-one, 1-oxa-13-cyclohexadecen-2-one, (+−)-2-methylundecanal, 2-methyldecanal, (3Z)-3-hexen-1-yl salicylate, (Z)-3-hexen-1-yl benzoate, patchouli oil, (1R,3R,6S,7S,8S)-2,2,6,8-tetramethyltricyclo[5.3.1.0^{3,8}]undecan-3-ol, (+−)-3-(4-methyl-3-penton-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal, (2E)-1-[(1RS,2SR)-2,6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one, limonene, 2,4,4,7-tetramethyl-6,8-nonadien-3-one oxime, 2-(4-methyl-3-cyclohexen-1-yl)-2-propanethiol, 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n-[3-(1,3-benzodioxo1-5-yl)-2-methyl-1-propenyl]anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethy loctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7,8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy-3,7-dimethyl-1-octenyl)anthranilate, methyl 2-(methylamino)benzoate, oxacyclohexadecan-2-one, oxacycloheptadecan-2-one, dodecahydro-3a,6,6,9a-tetramethyl-naphtho[2,1-b]furan or any of its stereoisomers, 1,1′-oxydibenzene, 4-methyl-2-phenyltetrahydro-2H-pyran, tetrahydro-4-methyl-2-(2-methyl-1-propenyl)-2H-pyran, (+−)-4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran, orange oil, 10-undecenal, 9-undecenal, decanal and a mixture thereof. In particular, the at least one perfuming ingredient having a LogP above 3 may be selected from the group consisting of 2-methyl-3-[4-(2-methyl-2-propanyl)phenyl]propanal, tricyclo[5.2.1.0(2,6)]dec-3-en-8-yl propanoate, tricyclo[5.2.1.0(2,6)]dec-4-en-8-yl propanoate, tricyclo[5.2.1.02,6]dec-3-en-8-yl acetate, tricyclo[5.2.1.02,6]dec-4-en-8-yl acetate, 2-methylbutyl salicylate, pentyl salicylate, benzyl salicyclate, tetrahydro-4-methyl-2-(2-methyl-1-propenyl)-2H-pyran, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl[ethanone, cyclohexyl 2-hydroxybenzoate, hexyl 2-hydroxybenzoate, cyclohexylidene(phenyl)acetonitrile, 1-oxa-12-cyclohexadecen-2-one, 1-oxa-13-cyclohexadecen-2-one, (+−)-2-methylundecanal, (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl[-2-buten-1-one, limonene, 2-methoxynaphthalene, oxacyclohexadecan-2-one, dodecahydro-3a,6,6,9a-tetramethyl-naphtho[2,1-b[furan or any of its stereoisomers, 1,1′-oxydibenzene, orange oil, 10-undecenal, 9-undecenal and a mixture thereof. Particularly, the perfuming composition comprises 2, 3, 4, 5, 6, 7, 8, 9, 10, 11, 12, 13, 14, 15, 16, 17, 18, 19, 20, 21, 22, 23, 24, 25 or more perfuming ingredient having a LogP above 3 selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3.5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1,6}]undecan-7-one, tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.02,6]dec-3-en-8-yl acetate, tricyclo[5.2.1.02,6]dec-4-en-8-yl acetate, 1-((2RS,3 RS)-2,3,8,8-tetramethyl-1,2,3,4,5,6,7,8-octahydronaphthalen-2-yl)ethanone, 1-[(2RS,3 RS,8aRS)-2,3,8,8-tetramethyl-1,2,3,5,6,7,8,8a-octahydro-2-naphthalenyl]ethanone, 14(2RS,3 RS,8aRS)-2,3,8,8-tetramethyl-1,2,3,4,6,7,8,8a-octahydro-2-naphthalenyl]ethanone, 1-[(1RS,2RS)-1,2,8,8-tetramethyl-1,2,3,4,5,6,7,8-octahydro-2-naphthalenyl]ethanone, 1-[(1RS,2RS,8aSR)-1,2,8,8-tetramethyl-1,2,3,5,6,7,8,8a-octahydro-2-naphthalenyl]ethenone, 1-(1,2,3,4,5,6,7,8-octahydro-2,3,8,8,-tetramethyl-2-naphthyl)ethan-1-one, (1-ethoxyethoxy)cyclododecane, (ethoxymethoxy)cyclododecane, cyclohexyl 2-hydroxybenzoate, 2-methylbutyl salicylate, pentyl salicylate, 2-phenylethyl 2-hydroxybenzoate, hexyl 2-hydroxybenzoate, benzyl salicylate, cyclohexylidene(phenyl)acetonitrile. dodecanenitrile, 3,7-dimethyl-6-octenenitrile, 2,6-nonadienenitrile, 2-tridecenenitrile, 3-tridecenenitrile, 3,7-dimethyl-2,6-nonadienenitrile, 2-phenyl-2-hexenenitrile, 3,12-tridecadienenitrile , 3-methyl-5-phenyl-2-pentenenitrile, 2-methyldecanenitrile, 1-oxa-12-cyclohexadecen-2-one, 1-oxa-13-cyclohexadecen-2-one, (+−)-2-methylundecanal, 2-methyldecanal, (3Z)-3-hexen-1-yl salicylate, (Z)-3-hexen-1-yl benzoate, patchouli oil, (1R,3R,6S,7S,8S)-2,2,6,8-tetramethyltricyclo[5,3,1.0^{3,8}]undecan-3-ol, (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal, (2E)-14(1RS,2SR)-2,6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one , 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one, limonene, 2,4,4,7-tetramethyl-6,8-nonadien-3-one oxime, 2-(4-methyl-3-cyclohexen-1-yl)-2-propanethiol, 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n-[341,3-benzodioxo1-5-yl)-2-methyl-1-propenyl]anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)aminoThenzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7,8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy-3,7-dimethyl-1-octenyl)anthranilate, methyl 2-(methylamino)benzoate, oxacyclohexadecan-2-one, oxacycloheptadecan-2-one, dodecahydro-3a,6,6,9a-tetramethyl-naphtho[2,1-b]furan or any of its stereoisomers, 1,1′-oxydibenzene, 4-methyl-2-phenyltetrahydro-2H-pyran, tetrahydro-4-methyl-2-(2-methyl-1-propenyl)-2H-pyran, (+−)-4-methylene-2-phenyl tetrahydro-2H-pyran, (+−)-4-methyl-6-phenyl-3,6-dihydro-2H-pyran, (+−)-4-methyl-2-phenyl-3,6-dihydro-2H-pyran,orange oil, 10-undecenal, 9-undecenal, decanal and a mixture thereof. Particularly, the perfuming composition comprises 2, 3, 4, 5, 6, 7, 8, 9, 10, 11, 12, 13, 14, 15, 16, 17, 18, 19, 20, 21, 22, 23, 24 or 25 perfuming ingredient having a LogP above 3 selected from the group consisting of 2-methyl-3-[4-(2-methyl-2-propanyl)phenyl]propanal, tricyclo[5.2.1.0(2,6)]dec-3-en-8-yl propanoate, tricyclo[5.2.1.0(2,6)]dec-4-en-8-yl propanoate, tricyclo[5.2.1.02,6]dec-3-en-8-yl acetate, tricyclo[5.2.1.02,6]dec-4-en-8-yl acetate, 2-methylbutyl salicylate, pentyl salicylate, benzyl salicyclate, tetrahydro-4-methyl-2-(2-methyl-1-propenyl)-2H-pyran, 1-((2RS,3RS)-2,3,8,8-tetramethyl-1,2,3,4,5,6,7,8-octahydronaphthalen-2-yl)ethanone, 1-R2RS,3RS,8aRS)-2,3,8,8-tetramethyl-1,2,3,5,6,7,8,8a-octahydro-2-naphthalenyflethanone, 1-R2RS,3RS, 8aRS)-2,3,8,8-tetrarnethyl-1,2,3,4,6,7,8,8a-octahydro-2-naphthalenyflethanone, cyclohexyl 2-hydroxybenzoate, hexyl 2-hydroxybenzoate, cyclohexylidene(phenyl)acetonitrile, 1-oxa-12-cyclohexadecen-2-one, 1-oxa-13-cyclohexadecen-2-one, (+−)-2-methylundecanal, (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl]-2-buten-1-one, limonene, 2-methoxynaphthalene, oxacyclohexadecan-2-one, dodecahydro-3a,6,6,9a-tetramethyl-naphtho[2,1-b]furan or any of its stereoisomers, 1,1′-oxydibenzene, orange oil, 10-undecenal and 9-undecenal. Particularly, the perfuming composition comprises at least 10 perfuming ingredients selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 4-(2-propanyl)cyclohexyl]methanol, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1,6}]undecan-7-one, 2-cyclohexylethyl acetate, 1-R1RS,2RS)-1,2,8,8-tetramethyl-1,2,3,4,5,6,7,8-octahydro-2-naphthalenyl]ethanone, 1-(1RS,2RS,8aSR)-1,2,8,8-tetramethyl-1,2,3,5,6,7,8,8a-octahydro-2-naphthalenyl]ethenone, 1-(1,2,3,4,5,6,7,8-octahydro-2,3,8,8,-tetramethyl-2-naphthyl)ethan-1-one, (1-ethoxyethoxy)cyclododecane, (ethoxymethoxy)cyclododecane, cyclohexyl 2-hydroxybenzoate, 2-methylbutyl salicylate, pentyl salicylate, 2-phenylethyl 2-hydroxybenzoate, hexyl 2-hydroxybenzoate, dodecanenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, 2-methyldecanal, (3Z)-3-hexen-1-yl salicylate, (Z)-3-hexen-1-yl benzoate, (1R,3R,6S,7S,8S)-2,2,6,8-tetramethyltricyclo[5.3.1.0^{3,8}]undecan-3-ol, (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal, (2E)-1-[(1RS,2SR)-2.6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one, limonene, 2,4,4,7-tetramethyl-6,8-nonadien-3-one oxime, 2-(4-methyl-3-cyclohexen-1-yl)-2-propanethiol, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyflanthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n-[3-(1,3-benzodioxo1-5-yl)-2-methyl-1-propenyl]anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy -3,7-di methyloctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene1]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methy 1propylidene]anthranilate, 2-ethoxy naphthalene, 1-(3-methyl-1-benzofuran-2-yl)ethanone, methyl 2-aminobenzoate, methyl n-(7-hydroxy-3,7-dimethyl-1-octenyl)anthranilate, oxacycloheptadecan-2-one, dodecahydro-3a,6,6,9a-tetramethyl-naphtho[2,1-b]furan or any of its stereoisomers, 1,1′-oxydibenzene, 4-methyl-2-phenyltetrahydro-2H-pyran, tetrahydro-4-methyl-2-(2-methyl-1-propenyl)-2H-pyran, (+−) -4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran, orange oil, 10-undecenal, 9-undecenal, decanal and a mixture thereof. Particularly, the perfuming composition comprises 2-methyl-3-[4-(2-methyl-2-propanyl)phenyllpropanal, cyclohexyl 2-hydroxybenzoate, hexyl 2-hydroxybenzoate, (3Z)-3-hexen-1-yl salicylate, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl]-2-buten-1-one, limonene, dodecahydro-3a,6,6,9a-tetramethyl-naphtho[2,1-b]furan or any of its stereoisomers, 1,1′-oxydibenzene and orange oil. Particularly, the perfuming composition comprises, as perfuming ingredient having a LogP above 3, at least one ingredient selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8 ,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{2,6}]undecan-7-one and a mixture thereof; at, least one ingredient, selected from the group consisting of tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0^{2,6}]dec-3-en-8-yl acetate, tricyclo[5.2.1.0^{2,6}]dec-4-en-8-yl acetate and a mixture thereof; at least one ingredient, selected from the group consisting of 1-((2RS,3RS)-2,3,8,8-tetramethyl-1,2,3,4,5,6,7,8-octah ydronaphth alen-2-yl)ethanone, 1-[(2RS,3 RS,8aRS)-2,3,8,8-tetramethyl-1,2,3,5,6,7,8,8a-octahydro-2-naphthalenyl]ethanone, 14(2RS,3RS,8aRS)-2,3,8,8-tetramethyl -1,2,3,4,6,7,8,8a-octahydro-2-naphthalenyl]ethanone, 1-[(1RS,2RS)-1,2,8,8-tetramethyl-1,2,3,4,5,6.7,8-octahydro-2-naphthalenyl]ethanone, 1-[(1RS,2RS,8aSR)-1,2,8,8-tetramethyl-1,2,3,5,6,7,8,8a-octahydro-2-naphthalenyl]ethenone, 1-(1,2,3,4,5,6,7,8-oct ahydro-2,3,8,8,-tetramethyl-2-naphthyl)ethan-1-one, (1-et hoxyethoxy)cyclododecane, (ethoxymethoxy)cyclododecane and a mixture thereof; at least one ingredient selected from the group consisting of cyclohexyl 2-hydroxybenzoate, 2-methylbutyl salicylate, pentyl salicylate, 2-phenylethyl 2-hydroxybenzoate and a mixture thereof; at least one ingredient selected from the group consisting of hexyl 2-hydroxybenzoate, benzyl salicylate and a mixture thereof; at least one ingredient, selected from the group consisting of cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, and a mixture thereof; at least a mixture comprising 1-oxa-12-cyclohexadecen-2-one and 1-oxa-13-cyclohexadecen-2-one; at least one ingredient selected from the group consisting of (+−)-2-methylundecanal, 2-methyldecanal and a mixture thereof; at least one ingredient selected from the group consisting of (3Z)-3-hexen-1-yl salicylate, (Z)-3-hexen-1-yl benzoate and a mixture thereof; at least one ingredient selected from the group consisting of patchouli oil, (1R,3R,6S,7S,8S)-2,2,6,8-tetramethyltricyclo[5.3.1.0^{3,8}]undecan-3-ol and a mixture thereof; at least one ingredient selected from the group consisting of (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-4-decenal, 2-decenal and a mixture thereof; at least one ingredient selected from the group consisting of (2E)-1-1(1RS,2SR)-2,6,6-trimethyl-3-cyclohexen-yl-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one and a mixture thereof; at least one ingredient, selected from the group consisting of limonene, 2,4,4,7-tetramethyl-6,8-nonadien-3-one oxime, 2-(4-methyl-3-cyclohexen-1-yl)-2-propanethiol and a mixture thereof; at least, one ingredient selected from the group consisting of 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methyl amino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n-13-(1,3-benzodioxol-5-yl)-2-methyl-1-propenyl1 anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{1(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7,8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy-3,7-dimethyl-1-octenyl)anthranilate, methyl 2-(methylamino)benzoate and a mixture thereof; at least one ingredient selected from the group consisting of oxacyclohexadecan-2-one, oxacycloheptadecan-2-one and a mixture thereof; at least dodecahydro-3a,6,6,9a-tetramethyl-naphtho[2,1-b]furan or any of its stereoisomers and a mixture thereof; at least one ingredient, selected from the group consisting of 1,1′-oxydibenzene, 4-methyl-2-phenyltetrahydro-2H-pyran, tetrahydro-4-methyl-2-(2-methyl-1-propenyl)-2H-pyran, (+−) -4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran; at least orange oil; and at least one ingredient selected from the group consisting of 10-undecenal, 9-undecenal, decanal and a mixture thereof. Particularly, the perfuming composition comprises as perfuming ingredient having a LogP above 3
a) at least one compound selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1,6}]undecan-7-one and a mixture thereof;
b) at least, one compound selected from the group consisting of tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0(2,6)]dec-3-en-8-yl acetate, tricyclo[5.2.1.0(2,6)]dec-4-en-8-yl acetate and a mixture thereof;
c) at least, one compound selected from the group consisting of 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, 1-[(1RS,2RS)-1,2,8,8-tetramethyl-1,2,3,4,5,6,7,8-octahydro-2-naphthalenyl] ethanone, 1-[(1RS,2RS,8aSR)-1,2,8,8-tetramethyl-1,2,3,5,6,7,8,8a-octahydro-2-naphthalenyl]ethenone, 1-(1,2,3,4,5,6,7,8-octahydro-2,3,8,8,-tetramethyl-2-naphthyl)ethan-1-one, (1-ethoxyethoxy)cyclododecane, (ethoxymethoxy)cyclododecane and a mixture thereof;
d) at least one compound selected from the group consisting of cyclohexyl 2-hydroxybenzoate, 2-methylbutyl salicylate, pentyl salicylate, 2-phenylethyl 2-hydroxybenzoate, hexyl 2-hydroxybenzoate, benzyl salicylate, (3Z)-3-hexen-1-yl salicylate, (Z)-3-hexen-1-yl benzoate and a mixture thereof;
e) at least one compound selected from the group consisting of cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile and a mixture thereof;
f) at least one compound selected from the group consisting of (+−)-2-methylundecanal, 2-methyldecanal and a mixture thereof;
g) at least one compound selected from the group consisting of patchouli oil, (1R,3R,6S,7S,8S)-2,2,6,8-tetramethyltricyclo[5.3.1.0^{3,8}]undecan-3-ol and a mixture thereof;
h) at least one compound selected from the group consisting of (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal and a mixture thereof;
i) at least one compound selected from the group consisting of (2E)-1-[(1 RS,2SR)-2,6,6-trimethyl-3-cyclohexen-1-yl]-2-buten-1-one, 1-(2,6,6-trimethyl-2-cyclohexen 1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one and a mixture thereof;
j) at least, one compound selected from the group consisting of limonene, 2,4,4,7-tetramethyl-6,8-nonadien-3-one oxime, 2-(4-methyl-3-cyclohexen-1-yl)-2-propanethiol, orange oil and a mixture thereof;
k) at least one compound selected from the group consisting of 2-methoxynaphthalene, methyl n-(2-hexyl-3-phenyl-2-propenylidene)anthranilate, methyl n-(3 ,5 ,5-trimethylhexylidene)anthranil ate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3-hydroxy-4-methylpentyl)-3-cyclohexen-1-ylidene]methyl}amino)benzoate, methyl n-benzylideneanthranilate, methyl n-(2-phenylethylidene)anthranilate, methyl n-[3-(1,3-benzodioxo1-5-yl)-2-methyl-1-propenyl]anthranilate, methyl n-[2-(4-methoxybenzyl)-1-propenyl] anthrani late, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7.8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy -3,7-dimethyl-1-octenyl)anthranilate, methyl 2-(methylamino)benzoate and a mixture thereof;
l) at least one compound selected from the group consisting of oxacyclohexadecan-2-one, oxacycloheptadecan-2-one, 1-oxa-12-cyclohexadecen-2-one, 1-oxa-13-cyclohexadecen-2-one and a mixture thereof;
m) at least one compound selected from the group consisting of dodecahydro-3a,6,6,9a-tetramethyl-naphtho[2,1-b]furan or any of its stereoisomers and a mixture thereof;
n) at least, one compound selected from the group consisting of 1,1′-oxydibenzene, 4-methyl-2-phenyltetrahydro-2H-pyran, tetrahydro-4-methyl-2-(2-methyl-1-propenyl)-2H-pyran, (+−)-4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran and a mixture thereof; and
o) at least one compound selected from the group consisting of 10-undecenal, 9-undecenal, decanal and a mixture thereof.

Particularly, the perfuming composition comprises as perfuming ingredient, having a LogP above 3:
a) at least one compound selected from the group consisting of 2-methyl-3-[4-(2-methyl-2-propanyl)phenyl]propanal, 3-(4-isobutyl-2-methylphenyepropanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8.8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1,6}]undecan-7-one and a mixture thereof;
b) at least two compounds selected from the group consisting of tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0^{2,6}]dec-3-en-8-yl acetate, tricyclo[5.2.1.0^{2,6}]dec-4-en-8-yl acetate and a mixture thereof;
c) at least, three compounds selected from the group consisting of 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-oclahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, 1-[(1RS.2RS)-1,2,8,8-tetramethyl-1,2,3,4,5,6,7,8-octahydro-2-naphthalenyl]ethanone, 1-R1RS,2RS,8aSR)-1,2,8,8-tetramethyl-1,2,3,5,6,7,8,8a-octahydro-2-naphthalenyliethenone, 1-(1,2,3,4,5,6,7,8-octahydro-2,3,8,8,-tetramethyl-2-naphthyl)ethan-1-one, ethoxyethoxy)cyclododecane, (ethoxymethoxy)cyclododecane and a mixture thereof;
d) at, least three compounds selected from the group consisting of cyclohexyl 2-hydroxybenzoate, 2-methylbutyl salicylate, pentyl salicylate, 2-phenylethyl 2-hydroxybenzoate, hexyl 2-hydroxybenzoate, benzyl salicylate, (3Z)-3-hexen-1-yl salicylate, (Z)-3-hexen-1-yl benzoate and a mixture thereof;
e) at least one compound selected from the group consisting of cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, and a mixture thereof;
f) at least one compound selected from the group consisting of (+−)-2-methylundecanal, 2-methyldecanal and a mixture thereof;
g) at least one compound selected from the group consisting of patchouli oil, (1R,3R,6S,7S,8S)-2,2,6,8-tetramethyltricyclo[5.3.1.0^{3,8}]undecan-3-ol and a mixture thereof;
h) at least two compounds selected from the group consisting of (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal and a mixture thereof;
i) at least, one compound selected from the group consisting of (2E)-1-[(1RS,2SR)-2,6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one and a mixture thereof;
j) at least two compounds selected from the group consisting of limonene, 2,4,4,7-tetramethyl-6,8-nonadien-3-one oxime, 2-(4-methyl-3-cyclohexen-1-yl)-2-propanethiol, orange oil and a mixture thereof;
k) at least one compound selected from the group consisting of 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n-[3-(1,3-benzodioxo1-5-yl)-2-methyl-1-propenyl]anthranilate, methyl n-{2-(4-methoxybenzyl)-1-propenyl}anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)amino]benzoate, methyl (3S)-n-(7-hydroxy-3,7-dimethyloctylidene)anthranilate, methyl n-{2-(4-methoxybenzyl)propylidene}anthranilate, ethyl 2-{[(2,4/3,5-dimethyl-3-cyclohexen-1-yl)methyl] amino }benzoate, ethyl 2-{[(1E)-(4-tert-butylphenyl)methylene]amino}benzoate, methyl n-(octylidene)anthranilate, methyl n-{3-(p-tert-butylphenyl)-2-methylpropylidene}anthranilate, methyl n-{3-(4-isopropyl-1-phenyl)-2-methylpropylidene}anthranilate, 2-ethoxynaphthalene, 1-(5,6,7,8-tetrahydro-2-naphthalenyl)ethanone, 1-(3-methyl-1-benzofuran-2-yl)ethanone, 1-(-naphthyl)elhanone, 1-(2-naphthyl)ethanone, methyl 2-aminobenzoate, methyl n-(7-hydroxy-3,7-dimethyl-1-octenyl)anthranilate, methyl 2-(methylamino)benzoate and a mixture thereof;
l) at, least two or three compounds selected from the group consisting of oxacyclohexadecan-2-one, oxacycloheptadecan-2-one, 1-oxa-12-cyclohexadecen-2-one, 1-oxa-13-cyclohexadecen-2-one and a mixture thereof;
m) at least one compound selected from the group consisting of dodecahydro-3a,6,6,9a-tetramethyl-naphtho{2,1-b}furan or any of its stereoisomers and a mixture thereof;
n) at least, one compound selected from the group consisting of 1,1′-oxydibenzene, 4-methyl-2-phenyltetrahydro-2H-pyran, tetrahydro-4-methyl-2-(2-methyl-1-propenyl)-2H-pyran, (+−)-4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran and a mixture thereof ; and
o) and at least two compounds selected from the group consisting of 10-undecenal, 9-undecenal, decanal and a mixture thereof.
   Even more particularly, the perfuming composition comprises 2-methyl-3-[4-(2-methyl-2-propanyl)phenyl]propanal, tricyclo[5.2.1.0(2,6)]dec-3-en-8-yl propanoate, tricyclo[5.2.1.0(2,6)]dec-4-en-8-yl propanoate, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3.8,8-tetramethyl-1,2,3,4,6,7,8,8a-octahydro-2-naphthalenyl]ethanone, cyclohexyl 2-hydroxybenzoate, hexyl 2-hydroxybenzoate, cyclohexylidene(phenyl)acetonitrile. 1-oxa-12-cyclohexadecen-2-one, 1-oxa-13-cyclohexadecen-2-one, (+−)-2-methylundecanal. (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-tri methyl-3-cyclohexen-1-yl]-2-buten-1-one, limonene, 2-methoxynaphthalene, oxacyclohexadecan-2-one, dodecahydro-3a,6,6,9a-tetramethyl-naphtho[2,1-b]furan or any of its stereoisomers, 1,1′-oxydibenzene, orange oil, and 9-undecenal. In other words, the perfuming composition comprises a mixture of all following ingredients: 2-methyl-3-[4-(2-methyl-2-propanyl)phenyl]propanal, tricyclo[5.2.1.0(2,6)]dec-3-en-8-yl propanoate, tricyclo[5.2.1.0(2,6)]dec-4-en-8-yl propanoate, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, cyclohexyl 2-hydroxybenzoate, hexyl 2-hydroxybenzoate, cyclohexylidene(phenyl)acetonitrile, 1-oxa-12-cyclohexadecen-2-one, 1-oxa-13-cyclohexadecen-2-one, (+−)-2-methy lundecanal. (3Z)-3-hexen-1-yl salicylate, patchouli oil, (+−)-3-(4-methyl-3-penten-1-yl)-3-cyclohexene-1-carbaldehyde. (+−)-4-(4-methyl-3-penten-1-yl)-3-cyclohexene-1-carbaldehyde, (2E)-1-[(1RS,2SR)-2,6,6-trimethyl-3-cyclohexen-1-yl] -2-buten-1-one, limonene, 2-methoxynaphthalene, oxacyclohexadecan-2-one, dodecahydro-3a,6,6,9a-tetramethyl-naphtho[2,1-b]furan or any of its stereoisomers, 1,1′-oxydibenzene, orange oil, and 9-undecenal. According to another particular embodiment, the perfuming composition comprises 2-methyl-3-[4-(2-methyl-2-propanyl)phenyl]propanal, tricyclo[5.2.1.0(2,6)]dec-3-en-8-yl propanoate, tricyclo[5.2.1.0(2,6)]dec-4-en-8-yl propanoate, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, cyclohexyl 2-hydroxybenzoate, hexyl 2-hydroxybenzoate, cyclohexylidene(phenyl)acetonitrile, 1-oxa-12-cyclohexadecen-2-one, 1-oxa-13-cyclohexadecen-2-one, (+−)-2-methylundecanal, (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl]-2-buten-1-one, limonene, 2-methoxynaphthalene, dodecahydro-3a,6,6,9a-tetramethyl-naphtho[2,1-b]furan or any of its stereoisomers, orange oil, tetrahydro-4-methyl-2-(2-methyl-1-propenyl)-2H-pyran, (1-ethoxyethoxy)cyclododecane, 10-undecenal and 9-undecenal. In other words, the perfuming composition comprises a mixture of all following ingredients: 2-methyl-3-[4-(2-methyl-2-propanyl)phenyl]propanal, tricyclo[5.2.1.0(2,6)]dec-3-en-8-yl propanoate, tricyclo[5.2.1.0(2,6)]dec-4-en-8-yl propanoate, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, cyclohexyl 2-hydroxybenzoate, hexyl 2-hydroxybenzoate, cyclohexylidene(phenyl)acetonitrile, 1-oxa-12-cyclohexadecen-2-one, 1-oxa-13-cyclohexadecen-2-one, (+−)-2-methy lundecanal, (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl]-2-buten-1-one, limonene, 2-methoxy naphthalene, dodecahydro-3a,6,6,9a-tetramethyl-naphtho[2,1-b]furan or any of its stereoisomers, orange oil, tetrahydro-4-methyl-2-(2-methyl-1-propenyl)-2H-pyran, (1-ethoxyethoxy)cyclododecane, 10-undecenal and 9-undecenal. According to another particular embodiment, the perfuming composition comprises 2-methyl-3-[4-(2-methyl-2-propanyl)phenyl]propanal, tricyclo[5.2.1.0^{2,6} ]dec-3-en-8-yl acetate, tricyclo[5.2.1.0^{2,6}]dec-4-en-8-yl acetate, cyclohexylidene(phenyl)acetonitrile, 1-oxa-12-cyclohexadecen-2-one, 1-oxa-13-cyclohexadecen-2-one, (+−)-2-methylundecanal, 2-methylbutyl salicylate, pentyl salicylate, benzyl salicylate, (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl]-2-buten-1-one. tetrahydro-4-methyl-2-(2-methyl-1-propenyl)-2H-pyran, 1-[(1RS,2RS)-1.2,8,8-tetramethyl-1,2,3,4,5,6,7,8-octahydro-2-naphthalenyl]ethenone, 1-((2RS,3RS)-2,3,8,8-tetramethyl-1,2,3,4,5,6,7,8-octahydronaphthalen-2-yl)ethenone, 1-[(2RS,3RS,8aRS)-2,3,8,8-tetramethyl-1,2,3,5,6,7,8,8a-octahydro-2-naphthalenyl]ethenone, 1-[(1RS,2RS,8aSR)-1,2,8,8-tetramethyl-1,2,3,5,6,7,8,8a-octahydro-2-naphthalenyl]ethenone, 1-[(2RS,3RS,8aRS)-2,3,8,8-tetramethyl-1,2,3,4,6,7,8,8a-octahydro-2-naphthalenyl]ethenone, limonene, 2-methoxynaphthalene, dodecahydro-3a,6,6,9a-tetramethyl-naphtho[2,1-b]furan or any of its stereoisomers, orange oil, 10-undecenal and 9-undecenal. In other words, the perfuming composition comprises a mixture of all following ingredients: 2-methyl-3-[4-(2-methyl-2-propanyl)phenyl]propanal, tricyclo[5.2.1.0^{2,6}]dec-3-en-8-yl acetate, tricyclo[5.2.1.0^{2,6}]dec-4-en-8-yl acetate, cyclohexylidene(phenyl)acetonitrile. 1-oxa-12-cyclohexadecen-2-one, 1-oxa-13-cyclohexadecen-2-one, (+−)-2-methylundecanal, 2-methylbutyl salicylate, pentyl salicylate, benzyl salicylate, (3Z)-3-hexen-1-yl salicylate, patchouli oil, (+−)-3-(4-methyl-3-penten-1-yl)-3-cyclohexene-1-carbaldehyde, (+−)-4-(4-methyl-3-penten-1-yl)-3-cyclohexene-1-carbaldehyde, (2E)-1-[(1RS,2SR)-2,6,6-trimethyl-3-cyclohexen-1-yl]-2-buten-1-one, tetrahydro-4-methyl-2-(2-methyl-1-propenyl)-2H-pyran, 1-[(1RS,2RS)-1,2,8,8-tetramethyl-1,2,3,4,5,6,7,8-octahydro-2-naphthalenyl]ethenone, 1-((2RS,3RS)-2,3,8,8-tetramethyl-1,2,3,4,5,6,7,8-octahydronaphthalen-2-yl)ethenone, 1-[(2 RS,3 RS,8aRS)-2,3,8,8-tetramethyl-1,2,3,5,6,7,8,8a-octahydro-2-naphthalenyl]ethenone, 1-[(1RS,2RS,8aSR)-1,2,8,8-tetrameth yl-1,2,3,5,6,7,8,8a-octahydro-2-naphthalenyl]ethenone, 1-[(2RS,3RS,8aRS)-2,3,8,8-tetramethyl-1,2,3,4,6,7,8,8a-octahydro-2-naphthalenyl]ethenone, limonene, 2-methoxynaphthalene, dodecahydro-3a,6,6,9a-tetramethyl-naphtho[2,1-b]furan or any of its stereoisomers, orange oil, 10-undecenal and 9-undecenal.

The expression “patchouli oil” designates any oil extracted from patchouli, any terpenes fractions of patchouli oil or Clearwood®.

The expression “dodecahydro-3a,6,6,9a-tetramethyl-naphtho[2,1-b]furan or any of its stereoisomers” has the normal meaning in the art; i.e. dodecahydro-3a,6,6,9a-tetramethyl-naphtho[2,1-b]furan comprises several stereocenter centers being carbon 3a, carbon 5a, carbon 9a and carbon 9b and each of said stereocenter can have two different stereochemistries (e.g. R or S). So, dodecahydro-3a,6,6,9a-tetramethyl-naphtho[2,1-b]furan may be in the form of a pure enantiomer or in the form of a mixture of enantiomers or diastereoisomers. Dodecahydro-3a,6,6,9a-tetramethyl-naphtho[2,1-b]furan can be in a racemic form or scalemic form. Therefore, dodecahydro-3a,6,6,9a-tetramethyl-naphtho[2,1-b]furan can be one stereoisomers or in the form of a composition of matter comprising, or consisting of, various stereoisomers, for example such as (−)-(3aR,5aS,9aS,9bR)-3a,6,6,9a-tetramethyldodecahydronaphtho[2,1-b] furan or (3aRS,5aSR,9aSR,9bRS)-3a,6,6,9a-tetramethyldodecahydronaphtho[2,1-b] furan.

The at least one perfuming ingredient can be added to the perfuming composition of matter in a large range of concentrations. In particular, the amount of each perfuming ingredient having a LogP above 3 may be comprised in the range between 0.01 to 30 wt %, preferably between 0.1 to 20 wt %, relative to the total weight of the perfuming composition of matter. In particular, the amount of 2-methyl-3-[4-(2-methyl-2-propanyl)phenyl]propanal may be comprised in the range between 5 to 30 wt %, preferably between 10 to 20 wt %, relative to the total weight of the perfuming composition of matter. In particular, the amount of tricyclo[5.2.1.0(2,6)]dec-3-en-8-yl propanoate and/or tricyclo[5.2.1.0(2,6)]dec-4-en-8-yl propanoate may be comprised in the range between 0.5 to 15 wt %, preferably between 1 to 10 wt %, relative to the total weight of the perfuming composition of matter. In particular, the amount of a mixture comprising 1-((2RS,3RS)-2,3,8,8-tetramethyl-1,2,3,4,5,6,7, 8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone and/or 1-[(2RS,3RS,8aRS)-2,3,8,8-tetramethyl-1,2,3,4,6,7,8,8a-octahydro-2-naphthalenyl]ethanone may be comprised in the range between 0.5 to 15 wt %, preferably between 1 to 10 wt %, relative to the total weight of the perfuming composition of matter. In particular, the amount of a mixture comprising tricyclo[5.2.1.0^{2,6}]dec-3-en-8-yl acetate and/or tricyclo[5.2.1.0^{2,6}]dec-4-en-8-yl acetate may be comprised in the range between 0.5 to 15 wt %, preferably between 1 to 10 wt %, relative to the total weight of the perfuming composition of matter. In particular, the amount of a mixture comprising 2-methylbutyl salicylate and/or pentyl salicylate may be comprised in the range between 0.5 to 15 wt %, preferably between 1 to 10 wt %, relative to the total weight of the perfuming composition of matter. In particular, the amount of benzyl salicyclate may be comprised in the range between 0.5 to 15 wt %, preferably between 1 to 10 wt %, relative to the total weight of the perfuming composition of matter. In particular, the amount of (1-ethoxyethoxy)cyclododecane may be comprised in the range between 0.1 to 5 wt %, preferably between 0.3 to 2 wt %, relative to the total weight of the perfuming composition of matter. In particular, the amount of tetrahydro-4-methyl-2-(2-methyl-1-propenyl)-2H-pyran may be comprised in the range between 0.1 to 5 wt %, preferably between 0.3 to 2 wt %, relative to the total weight of the perfuming composition of matter. In particular, the amount of cyclohexyl 2-hydroxybenzoate may be comprised in the range between 0.5 to 15 wt %, preferably between 1 to 10 wt %, relative to the total weight of the perfuming composition of matter. In particular, the amount of hexyl 2-hydroxybenzoate may be comprised in the range between 0.5 to 15 wt %, preferably between 1 to 10 wt %, relative to the total weight of the perfuming composition of matter. In particular, the amount of cyclohexylidene(phenyl)acetonitrile may be comprised in the range between 0.5 to 15 wt %, preferably between 1 to 10 wt %, relative to the total weight, of the perfuming composition of matter. In particular, the amount of 1-oxa-12-cyclohexadecen-2-one and/or 1-oxa-13-cyclohexadecen-2-one may be comprised in the range between 0.5 to 15 wt %, preferably between 1 to 10 wt %, relative to the total weight of the perfuming composition of matter. In particular, the amount of (+−)-2-methylundecanal may be comprised in the range between 0.5 to 15 wt %, preferably between 1 to 10 wt %, relative to the total weight of the perfuming composition of matter. In particular, the amount of (3Z)-3-hexen-1-yl salicylate may be comprised in the range between 0.5 to 15 wt %, preferably between 1 to 10 wt %, relative to the total weight of the perfuming composition of matter. In particular, the amount of patchouli oil may be comprised in the range between 0.5 to 15 wt %, preferably between 1 to 10 wt %, relative to the total weight of the perfuming composition of matter. In particular, the amount of a mixture comprising (+−)-3-(4-methyl-3-penten-1-yl)-3-cyclohexene-1-carbaldehyde and/or (+−)-4-(4-methyl-3-penten-1-yl)-3-cyclohexene-1-carbaldehyde may be comprised in the range between 0.5 to 15 wt %, preferably between 1 to 10 wt %, relative to the total weight of the perfuming composition of matter. In particular, the amount of (2E)-1-[(1RS,2SR)-2,6,6-trimethyl-3-cyclohexen-1-yl]-2-buten-1-one may be comprised in the range between 0.5 to 10 wt %, preferably between 1 to 5 wt %, relative to the total weight of the perfuming composition of matter. In particular, the amount of limonene may be comprised in the range between 0.5 to 10 wt %, preferably between 1 to 5 wt %, relative to the total weight, of the perfuming composition of matter. In particular, the amount of 2-methoxynaphthalene may be comprised in the range between 0.5 to 10 wt %, preferably between 1 to 5 wt %, relative to the total weight of the perfuming composition of matter. In particular, the amount of oxacyclohexadecan-2-one may be comprised in the range between 0.5 to 10 wt %, preferably between 1 to 5 wt %, relative to the total weight of the perfuming composition of matter. In particular, the amount, of dodecahydro-3a,6,6,9a-tetramethyl-naphtho[2,1-b]furan or any of its stereoisomers may be comprised in the range between 0.1 to 5 wt %, preferably between 0.5 to 2 wt %, relative to the total weight of the perfuming composition of matter. In particular, the amount of 1,1′-oxydibenzene may be comprised in the range between 0.1 to 2 wt %, preferably between 0.2 to 1 wt %, relative to the total weight of the perfuming composition of matter. In particular, the amount of orange oil may be comprised in the range between 0.05 to 5 wt %, preferably between 0.1 to 2 wt %, relative to the total weight of the perfuming composition of matter. In particular, the amount of a mixture comprising 10-undecenal and 9-undecenal may be comprised in the range between 0.05 to 1 wt %, preferably between 0.1 to 0.5 wt %, relative to the total weight of the perfuming composition of matter.

In a particular embodiment, the invention's perfuming composition of matter comprises the perfuming ingredient having a LogP above 3 in an amount of from 50 wt. % to 99.95 wt. %, preferably from 70 wt. % to 99.9 wt. %, preferably from 75 wt. % to 99.5 wt. %, preferably from 80 wt. % to 99 wt. %, preferably from 90 wt. % to 99 wt. %, based on the total weight of the perfume composition.

As mentioned above, the perfuming composition of matter above described show an increased the perception of the perfume over several days. Therefore another object of the present invention is the use as perfuming ingredients of the invention's perfuming composition of matter. In particular, and in other words, a method or a process to confer, enhance, improve or modify the odor properties of a perfuming composition or of a perfumed article or of a surface, which method comprises adding to said composition or article an effective amount of the perfuming composition of matter according to the invention. For instance, the overall effect imparted by the use of said composition of matter is thus a long lasting effect.

By “use of the perfuming composition of matter” it, has to be understood here also the use of any composition containing said composition of matter and which can be advantageously employed in perfumery industry as active ingredients.

Therefore, another object of the present invention is a perfuming composition comprising:
i) as perfuming ingredient, an invention's perfuming composition of matter as defined above;
ii) at least one ingredient selected from the group consisting of a perfumery carrier and a perfumery base; and
iii) optionally at least one perfumery adjuvant.

By “perfumery carrier” it is meant here a material which is practically neutral from a perfumery point of view, i.e. that does not significantly alter the organoleptic properties of perfuming ingredients. Said carrier may be a liquid or a solid.

As liquid carrier one may cite, as non-limiting examples, an emulsifying system, i.e. a solvent and a surfactant system, or a solvent commonly used in perfumery. A detailed description of the nature and type of solvents commonly used in perfumery cannot be exhaustive. However, one can cite as non-limiting examples, solvents such as butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, isopropyl palmitate, benzyl benzoate, benzyl alcohol, 2-(2-ethoxyethoxy)-1-ethano, tri-ethyl citrate or mixtures thereof, which are the most commonly used. For the compositions which comprise both a perfumery carrier and a perfumery base, other suitable perfumery carriers than those previously specified, can be also ethanol, water/ethanol mixtures, terpenes, isoparaffins such as those known under the trademark Isopar (origin: Exxon Chemical) or glycol ethers and glycol ether esters such as those known under the trademark Dowanol (origin: Dow Chemical Company), or hydrogenated castors oils such as those known under the trademark Cremophor RH 40 (origin: BASF). Particularly, the invention's composition may comprise isopropyl myristate or isopropyl palmitate. The amount of isopropyl myristate, may be comprised in the range between 0.5 to 10 wt %, preferably between 1 to 5 wt %, relative to the total weight of the perfuming composition.

Solid carrier is meant to designate a material to which the perfuming composition or some element of the perfuming composition can be chemically or physically bound. In general such solid carriers are employed either to stabilize the composition, or to control the rate of evaporation of the compositions or of some ingredients. Solid carriers are of current use in the art and a person skilled in the art knows how to reach the desired effect. However by way of non-limiting examples of solid carriers, one may cite absorbing gums or polymers or inorganic materials, such as porous polymers, cyclodextrins, wood based materials, organic or inorganic gels, clays, gypsum talc or zeolites.

As other non-limiting examples of solid carriers, one may cite encapsulating materials. Examples of such materials may comprise wall-forming and plasticizing materials, such as mono, di- or trisaccharides, natural or modified starches, hydrocolloids, cellulose derivatives, polyvinyl acetates, polyvinylalcohols, proteins or pectins, or yet the materials cited in reference texts such as H. Scherz, Hydrokolloide: Stabilisatoren, Dickungs- and Geliermittel in Lebensmitteln, Band 2 der Schriftenreihe Lebensmittelchemie, Lebensmittelqualität, Behr's Verlag GmbH & Co., Hamburg, 1996. The encapsulation is a well-known process to a person skilled in the art, and may be performed, for instance, by using techniques such as spray-drying, agglomeration or wet extrusion; or consists of a coating encapsulation, including coacervation and complex coacervation techniques.

As non-limiting examples of solid carriers, one may cite in particular the core-shell capsules with resins of aminoplast, polyamide, polyester, polyurea or polyurethane type or a mixture thereof (all of said resins are well known to a person skilled in the art) using techniques like phase separation process induced by polymerization, interfacial polymerization, coacervation or altogether (all of said techniques have been described in the prior art), optionally in the presence of a polymeric stabilizer or of a cationic copolymer.

Resins may be produced by the polycondensation of an aldehyde (e.g. formaldehyde, 2,2-dimethoxyethanal, glyoxal, glyoxylic acid or glycolaldehyde and mixtures thereof) with an amine such as urea, benzoguanamine, glycoluryl, melamine, methylol melamine, methylated methylol melamine, guanazole and the like, as well as mixtures thereof. Alternatively one may use preformed resins alkylolated polyamines such as those commercially available under the trademark Urac® (origin: Cytec Technology Corp.), Cymel® (origin: Cytec Technology Corp.), Urecoll® or Luracoll® (origin: BASF).

Other resins are the ones produced by the polycondensation of an a polyol, like glycerol, and a polyisocyanate, like a trimer of hexamethylene diisocyanate, a trimer of isophorone diisocyanate or xylylene diisocyanate or a Biuret of hexamethylene diisocyanate or a trimer of xylylene diisocyanate with trimethylolpropane (known with the tradename of Takenate®, origin: Mitsui Chemicals), among which a trimer of xylylene diisocyanate with trimethylolpropane and a Biuret of hexamethylene diisocyanate are preferred.

Some of the seminal literature related to the encapsulation of perfumes by polycondensation of amino resins, namely melamine based resins with aldehydes includes articles such as those published by K. Dietrich et al. Acta Polymerica, 1989, vol. 40, pages 243, 325 and 683, as well as 1990, vol. 41, page 91. Such articles already describe the various parameters affecting the preparation of such core-shell microcapsules following prior art methods that are also further detailed and exemplified in the patent literature. U.S. Pat. No. 4,396,670, to the Wiggins Teape Group Limited is a pertinent early example of the latter. Since then, many other authors have enriched the literature in this field and it would be impossible to cover all published developments here, but the general knowledge in encapsulation technology is very significant. More recent publications of pertinence, which disclose suitable uses of such microcapsules, are represented for example by the article of K. Bruyninckx and M. Dusselier, ACS Sustainable Chemistry & Engineering, 2019, vol. 7, pages 8041-8054.

By “perfumery base” what is meant here is a composition comprising at least one perfuming co-ingredient.

Said perfuming co-ingredient is not a perfuming ingredient having a LogP above 3 as listed above. Moreover, by “perfuming co-ingredient” it is meant here a compound, which is used in a perfuming preparation or a composition to impart a hedonic effect. In other words such a co-ingredient, to be considered as being a perfuming one, must be recognized by a person skilled in the art as being able to impart or modify in a positive or pleasant way the odor of a composition, and not just as having an odor.

The nature and type of the perfuming co-ingredients present in the base do not warrant a more detailed description here, which in any case would not be exhaustive, the skilled person being able to select them on the basis of his general knowledge and according to the intended use or application and the desired organoleptic effect. In general terms, these perfuming co-ingredients belong to chemical classes as varied as alcohols, lactones, aldehydes, ketones, esters, ethers, acetates, nitriles, terpenoids, nitrogenous or sulphurous heterocyclic compounds and essential oils, and said perfuming co-ingredients can be of natural or synthetic origin. In particular one may cite perfuming co-ingredients which are commonly used in perfume formulations, such as:
Aldehydic ingredients: decanal, dodecanal, 2-methyl-undecanal, octanal, nonenal and/or nonenal;
Aromatic-herbal ingredients: eucalyptus oil, camphor, eucalyptol, 5-methyltricyclo[6.2.1.0^{2,7}]undecan-4-one, 1-methoxy-3-hexanethiol, 2-ethyl-4,4-dimethyl-1,3-oxathiane, 2,2,7/8,9/10-Tetramethy lspiro[5.5]undec-8-en-1-one, menthol and/or alpha-pinene;
Balsamic ingredients: coumarin, ethylvanillin and/or vanillin;
Citrus ingredients: dihydromyrcenol, citral, linalyl acetate, citronellyl nitrile, orange terpenes, 1-p-menthen-8-yl acetate and/or 1,4(8)-p-menthadiene;
Floral ingredients:methyl dihydrojasmonate, linalool, citronellol, phenylethanol, hexylcinnamic aldehyde, benzyl acetate, benzyl benzoate, beta ionone, (E)-3-methyl-4-(2,6,6-trimethyl-2-cyclohexen-1-yl)-3-buten-2-one, (1E)-1-(2,6,6-trimethyl-2-cyclohexen-1-yl)-1-penten-3-one, 1-(2,6,6-trimethyl-1,3-cyclohexadien-1-yl)-2-buten-1-one, (2E)-1-(2,6,6-trimethyl-2-cyclohexen-1-yl)-2-buten-1-one, (2E)-1-(2,6,6-trimethyl-1-cyclohexen-1-yl)-2-buten-1-one, 2,5-dimethyl-2-indanmethanol, 2,6,6-trimethyl-3-cyclohexene-1-carboxylate, 3-(4,4-dimethyl-1-cyclohexen-1-yl)propanal, 3,7-dimethyl-1,6-nonadien-3-ol, 3-(4-isopropylphenyl)-2-methylpropanal, geraniol, p-menth-1-en-8-ol, dimethylethyl)-1-cyclohexyle acetate, 1,1-dimethyl-2-phenylethyl acetate, 4-cyclohexyl-2-methyl-2-butanol, amyl salicylate, high cis methyl dihydrojasmonate, 3-methyl-5-phenyl-1-pentanol, geranyl acetate, tetrahydro linalool, cis-7-p-menthanol, propyl (S)-2-(1,1-dimethylpropoxy)propanoate, 2,2,2-trichloro-1-phenylethyl acetate, amylcinnamic aldehyde, 8-decen-5-olide, 4-phenyl-2-butanone, isononyle acetate, 4-(1,1-dimethylethyl)-1-cyclohexyl acetate, verdyl isobutyrate and/or mixture of methylionones isomers;
Fruity ingredients: gamma-undecalactone, 2,2,5-trimethyl-5-pentylcyclopentanone, 2-methyl-4-propyl-1,3-oxathiane, 4-decanolide, ethyl 2-methyl-pentanoate, hexyl acetate, ethyl 2-methylbutanoate, gamma-nonalactone, allyl heptanoate, 2-phenoxyethyl isobutyrate, ethyl 2-methyl-1,3-dioxolane-2-acetate, 3-(3,3/1,1-dimethyl-5-indanyl)propanal, diethyl 1,4-cyclohexanedicarboxylate, 3-methyl-2-hexen-1-yl acetate, 1-[3,3-dimethylcyclohexyl]ethyl [3-ethyl-2-oxiranyl]acetate and/or diethyl 1,4-cyclohexane dicarboxylate;
Green ingredients: 2-methyl-3-hexanone (E)-oxime, 2,4-dimethyl-3-cyclohexene 1-carbaldehyde, 2-tert-butyl-1-cyclohexyl acetate, styrallyl acetate, allyl (2-methylbutoxy)acetate, 4-methyl-3-decen-5-ol, (Z)-3-hexen-1-ol and/or 1-(5,5-dimethyl-1-cyclohexen-1-yl)-4-penten-1-one;
Musk ingredients: 1,4-dioxa-5,17-cycloheptadecanedione, (Z)-4-cyclopentadecen-1-one, 3-methylcyclopentadecanone, (9Z)-9-cycloheptadecen-1-one, 2-{1S)-1-[(1R)-3,3-dimethylcyclohexyl]ethoxy}-2-oxoethyl propionate 3-methyl-5-cyclopentadecen-1-one, 1,3,4,6,7,8-hexahydro-4,6,6,7,8,8-hexamethyl-cyclopenta-g-2-benzopyrane, (1S,1′R)-2[-(1-3′,3′-dimethyl-1′-cyclohexyl)ethoxy]-2-methylpropyl propanoate and/or (1S, 1′R)-[1-(3′,3′-dimethyl-cyclohexyl)ethoxycarbonyl]methyl propanoate;
Woody ingredients: 1-[(1RS,6SR)-2,2,6-trimethylcyclohexyl]-3-hexanol, 3,3-dimethyl-5-[(1R)-2,2,3-trimethyl-3-cyclopenten-1-yl]-4-penten-2-ol, 3,4′-dimethylspiro[oxirane-2,9′-tricyclo[6.2.1.0^{2,7}]undec[4]ene, 2,2,9,11-tetramethylspiro[5.5]undec-8-en-1-yl acetate, (1′R,E)-2-ethyl-4-(2′,2′,3′-trimethyl-3′-cyclopenten-1′-yl)-2-buten-1-ol, 2-ethyl-4-(2,2,3-trimethyl-3-cyclopenten-1-yl)-2-buten-1-ol, methyl cedryl ketone, 5-(2,2,3-trimethyl-3-cyclopentenyl)-3-methylpentan-2-ol, 1-(2,3,8,8-tetramethyl-1,2,3,4,6,7,8,8a-octahydronaphthalen-2-yl)ethan-1-one and/or isobornyl acetate;
Other ingredients (e.g. amber, powdery spicy or watery): heliotropin, anisic aldehyde, eugenol, cinnamic aldehyde, clove oil, 3-(1,3-benzodioxol-5-yl)-2-methylpropanal, 7-methyl-2H-1,5-benzodioxepin-3(4H)-one, 2,5,5-trimethyl-1,2,3,4,4a,5,6,7-octahydro-2-naphthalenol, 1-phenylvinyl acetate, 6-methyl-7-oxa-1-thia-4-azaspiro[4.4] nonan and/or 3-(3-isopropyl-1-phenyl)butanal.

A perfumery base according to the invention may not be limited to the above mentioned perfuming co-ingredients, and many other of these co-ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of perfumery.

By “perfumery adjuvant”, it is meant here an ingredient capable of imparting additional added benefit such as a color, a particular light resistance, chemical stability, etc. A detailed description of the nature and type of adjuvant commonly used in perfuming composition cannot be exhaustive, but, it, has to be mentioned that said ingredients are well known to a person skilled in the art. One may cite as specific non-limiting examples the following: viscosity agents (e.g. surfactants, thickeners, gelling and/or rheology modifiers), stabilizing agents (e.g. preservatives, antioxidant, heat/light and or buffers or chelating agents, such as BHT), coloring agents (e.g. dyes and/or pigments), preservatives (e.g. antibacterial or antimicrobial or antifungal or anti irritant agents), abrasives, skin cooling agents, fixatives, insect repellants, ointments, vitamins and mixtures thereof.

Other suitable perfumery adjuvants optionally used in combination with the perfuming composition according to the present invention comprise amine such as monoethanolamine or tertiary amines, in particular those with high water solubility, such as triethanolamine, triethylamine, methyldiethanolamine, dimethy le thanolam ine, 1,1′, 1″, 1′″-[1,2-ethanediyldi(nitrilo)]tetra(2-propanol), alkyldiethanolamines and ethoxylated alkyldiethanolamines.

A particular aspect of the invention's perfumery compositions concerns the ones further comprising (in addition to the above-mentioned compositions) at least one compound selected amongst the isothiazolones of formula

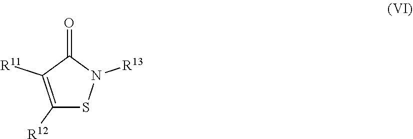

wherein
R¹¹ and R¹² represent, separately and independently of each other, a hydrogen atom, a halogen atom, preferably chlorine, a C₁-C₄ linear or branched alkyl group, an amino group or a benzylainino group; or, alternatively, R¹¹ and R¹² are taken together to represent a phenyl or pyridine ring, possibly substituted with one to four C₁-C₄ linear or branched alkyl or alkenyl groups and/or one to two halogen atoms, preferably chlorine atoms; and R¹³ represents a hydrogen atom, an alkali metal atom, in particular Na or K, a phenyl or benzyl group possibly substituted with one or two halogen atoms and/or one or two methyl, trifluoromethyl, methoxy or amino groups, an amine group, or a C₁-C₈ unsaturated, linear, branched or cyclic hydrocarbon group possibly substituted with one or two nitrogen, oxygen or halogen atoms.

According to a particular embodiment of the invention said compound of formula (VI) is one wherein R¹¹ and R¹² represent, separately and independently of each other, a hydrogen atom, a chlorine atom or a methyl group or, alternatively, R¹¹ and R¹² are taken together to represent a phenyl ring, and R¹³ represents a hydrogen atom or a methyl group.

According to a particular embodiment of the invention, said compound of formula (VI) is selected from the group of isothiazolones consisting of 1,2-benzisothiazol-3(2H)-one, 4- or 5-chloro-2-methylisothiazol-3(2H)-one or 2-methylisothiazol-3(2H)-one, or more preferably 5-chloro-2-methylisothiazol-3(2H)-one or 1,2-benzisothiazol-3(2H)-one, and most preferably 1,2-benzisothiazol-3(2H)-one.

According to a particular embodiment of the invention, said compound of formula (VI) is present in the compositions of the invention at a weight concentration of 0.0% to 5%, relative to the total weight of the composition. According to more preferred embodiments of the invention, the concentration of compound of formula (VI) is comprised between 0.001 and 3% of the total weight, preferably between 0.005 and 0.1%.

It is understood that a person skilled in the art is perfectly able to design optimal formulations for the desired effect by admixing the above mentioned components of a perfuming composition, simply by applying the standard knowledge of the art as well as by trial and error methodologies.

An invention's composition consisting of at least one profragrance compound, at least one perfuming ingredient having a LogP above 3 and at least one perfumery carrier consists of a particular embodiment of the invention as well as a perfuming composition comprising at least one profragrance compound, at least one perfuming ingredient having a LogP above 3, at least one perfumery carrier, at least one perfumery base, and optionally at least one perfumery adjuvant.

According to a particular embodiment, the compositions mentioned above, comprise more than one perfuming co-ingredients and enable the perfumer to prepare accords or perfumes possessing the desired odor tonality, creating thus new building block for creation purposes.

For the sake of clarity, it is also understood that any mixture resulting directly from a chemical synthesis, e.g. a reaction medium without an adequate purification, in which the invention's composition would be involved as a starting, intermediate or end-product could not be considered as a perfuming composition according to the invention as far as said mixture does not provide the inventive composition in a suitable form for perfumery. Thus, unpurified reaction mixtures are generally excluded from the present invention unless otherwise specified.

The invention's perfuming composition can also be advantageously used in all the fields of modern perfumery, i.e. fine or functional perfumery, to positively impart or modify the odor of a consumer product into which said perfuming composition is added. Consequently, another object of the present invention consists of by a perfumed consumer product comprising, the invention's perfuming composition.

The invention's composition of matter can be added as such or as part of a perfuming composition.

For the sake of clarity, “perfumed consumer product” is meant to designate a consumer product which delivers at least a pleasant perfuming effect to the surface or space to which it is applied (e.g. skin, hair, textile, paper or home surface) or in the air (air-freshener, deodorizer etc.). In other words, a perfumed consumer product according to the invention is a manufactured product which comprises a functional formulation, as well as optionally additional benefit, agents, corresponding to the desired consumer product, and an olfactive effective amount, of at least one invention's composition of matter. For the sake of clarity, said perfumed consumer product is a non-edible product.

The nature and type of the constituents of the perfumed consumer product do not warrant a more detailed description here, which in any case would not be exhaustive, the skilled person being able to select them on the basis of his general knowledge and according to the nature and the desired effect of said product.

Non-limiting examples of suitable perfumed consumer products include a perfume, such as a fine perfume, a splash or eau de parfum, a cologne or a shave or after-shave lotion; a fabric care product, such as a liquid, a pod or solid detergent or tablet, a fabric softener, a liquid or solid scent booster, a dryer sheet, a fabric refresher, an ironing water, a paper, a bleach, a carpet cleaner, a curtain-care product; a body-care product, such as a hair care product (e.g. a shampoo, a leave-on or rinse-off hair conditioner, a coloring preparation or a hair spray, a color-care product, a hair shaping product, a dental care product), a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc.); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner. In particular, the perfumed consumer product may be selected from the list consisting of fabric care product, such as a liquid, a pod or solid detergent or a, a fabric softener, a liquid or solid scent booster, a fabric refresher, an ironing water.

According to any embodiment of the invention, the perfumed consumer product may also comprise zinc salt such as zinc ricinoleate, zinc acetate and/or zinc stearate, laureth-3, tetrahydroxypropyl ethylenediamine, propylene glycol or a mixture thereof.

Another object of the invention is a perfumed consumer product comprising:
a personal care active base, and
the perfuming composition of matter or the perfuming composition as defined above,

wherein the consumer product is in the form of a personal care composition.

By “a personal care active base”, it is meant here ingredient(s) capable of imparting a benefit associated with the consumer product such as texture, moisturizing agent, etc . . . The active base comprises ingredients that are common in the perfumed consumer products. The active base of a perfumed consumer product depend on the nature of the perfumed consumer product and can be found in the abundant literature relative to such products. These formulations do not warrant a detailed description here which would in any case not be exhaustive. The person skilled in the art of formulating such consumer products is perfectly able to select the suitable components on the basis of his general knowledge and of the available literature.

The personal care composition is preferably chosen from the group consisting of a hair-care product (e.g. a shampoo, hair conditioner, a coloring preparation or a hair spray), a cosmetic preparation (e.g. a vanishing cream, body lotion or a deodorant or antiperspirant), or a skin-care product (e.g. a perfumed soap, shower or bath mousse, body wash, oil or gel, bath salts, or a hygiene product);

Another object of the invention is a perfumed consumer product comprising:
a home care or a fabric care active base, and
the perfuming composition of matter or the perfuming composition as defined above,

wherein the consumer product is in the form of a home care or a fabric care composition.

By “a home care or a fabric care active base”, it is meant here ingredient(s) capable of imparting a benefit associated with the consumer product such as texture, moisturizing agent, etc . . . The active base comprises ingredients that are common in the perfumed consumer products. The active base of a perfumed consumer product depend on the nature of the perfumed consumer product and can be found in the abundant literature relative to such products. These formulations do not warrant a detailed description here which would in any case not be exhaustive. The person skilled in the art of formulating such consumer products is perfectly able to select the suitable components on the basis of his general knowledge and of the available literature.

The main functional components of a personal care active base or a home care or a fabric care active bases are surfactants and/or softener components capable of cleaning and/or softening fabrics and/or textiles of varied nature, such as clothes, curtain fabrics, carpet and furniture fabrics, etc, or other home surfaces, skin or hair, and typically used in a large amount of water or water-based solvents. These are therefore formulations wherein the amount of water is typically comprised between 50 and 99% by weight of the active base with the exception of soap or solid detergent wherein the amount of water is at most 20%. The term “base” is used here in the sense of the main component of the composition according to the invention and not in the sense of a liquid having a basic pH.

Preferably, the consumer product comprises from 0.01 to 20 wt %, more preferably between 0.05 and 10 wt % of the perfuming composition of matter of the present invention, these percentages being defined by weight relative to the total weight of the consumer product. Of course, the above concentrations may be adapted according to the benefit effect desired in each product.

An object of the invention is a consumer product in the form of a fabric softener composition comprising:
a fabric softener active base, preferably in an amount comprised between 85 and 99.99% by weight based on the total weight of the composition,
a perfuming composition of matter as defined above, preferably in an amount comprised between 0.01 to 15 wt %, more preferably between 0.05 and 5 wt % by weight based on the total weight of the composition.

The fabric softener active base may comprise dialkyl quaternary ammonium salts, dialkyl ester quaternary ammonium salts (esterquats), Hamburg esterquat (HEQ), triethanolamine quat (TEAQ), cationic guars, silicones and mixtures thereof. Optionally, the fabric softener active base of the composition may further comprise a viscosity modifier in an amount comprised between 0.05 and 1% by weight, based on the total weight of the liquid base; preferably chosen in the group consisting of calcium chloride.

An object of the invention is a consumer product in the form of a liquid detergent composition comprising:
a liquid detergent active base, preferably in an amount comprised between 85 and 99.99% by weight based on the total weight of the composition,
a perfuming composition of matter as defined above, preferably in an amount comprised between 0.01 to 15 wt %, more preferably between 0.05 and 5 wt % by weight based on the total weight of the composition.

The liquid detergent active base may comprise anionic surfactant such as alkylbenzenesulfonate (ABS), linear alkylbenzene sulfonates (LAS), secondary alkyl sulfonate (SAS), primary alcohol sulfate (PAS), lauryl ether sulfate (LES), sodium lauryl ether sulfate (SLES), methyl ester sulfonate (MES) and nonionic surfactant such as alkyl Is amines, alkanolamide, fatty alcohol poly(ethylene glycol) ether, fatty alcohol ethoxylate (FAE), ethylene oxide (E0) and propylene oxide (PO) copolymers, amine oxydes, alkyl polyglucosides, alkyl polyglucosamides.

An object of the invention is a consumer product in the form of a solid detergent composition comprising:
a solid detergent active base, preferably in an amount comprised between 85 and 99.95% by weight based on the total weight of the composition,
a perfuming composition of matter as defined above, preferably in an amount comprised between 0.05 to 15 wt %, more preferably between 0.1 and 5 wt % by weight based on the total weight of the composition.

The solid detergent active base may comprises at least one surfactant chosen in the group consisting of anionic, nonionic, cationic, zwiterionic surfactant and mixtures thereof. The surfactant in the solid detergent active base is preferably chosen in the group consisting of linear alkene benzene sulphonate (LABS), sodium laureth sulphate, sodium lauryl ether sulphate (SLES), sodium lauryl sulphate (SLS), alpha olefin sulphonate (AOS), methyl ester sulphonates (MES), alkyl polyglyucosides (APG), primary alcohol ethoxylates and in particular lauryl alcohol ethoxylates (LAE), primary alcohol sulphonates (PAS), soap and mixtures thereof. The soild detergent active base may comprise optionally a further component, commonly used in powder detergent consumer product, selected from the group consisting of bleaching agents such as TAED (tetraacetylethylenediamine); buffering agent; builders such as zeolites, sodium carbonate or mixture thereof; soil release or soil suspension polymers; granulated enzyme particles such as cellulase, lipase, protease, mannanase, pectinase or mixtures thereof; corrosion inhibitor; antifoaming; sud suppressing agents; dyes; fillers such as sodium silicate, sodium sulfate or mixture thereof; source of hydrogen peroxide such as sodium percarbonate or sodium perborate; and mixtures thereof.

An object of the invention is a consumer product in the form of a solid scent booster comprising:
a solid carrier, preferably chosen from the group consisting of urea, sodium chloride, sodium sulphate, sodium acetate, zeolite, sodium carbonate, sodium bicarbonate, clay, talc, calcium carbonate, magnesium sulfate, gypsum, calcium sulfate, magnesium oxide, zinc oxide, titanium dioxide, calcium chloride, potassium chloride, magnesium chloride, zinc chloride, saccharides such as sucrose, mono-, di-, and polysaccharides and derivatives such as starch, cellulose, methyl cellulose, ethyl cellulose, propyl cellulose, polyols/sugar alcohols such as sorbitol, maltitol, xylitol, erythritol, and isomalt, PEG, PVP, citric acid or any water soluble solid acid, fatty alcohols or fatty acids and mixtures thereof;
a perfuming composition of matter, preferably in an amount comprised between 0.05 to 20 wt %, more preferably between 0.1 and 15 wt % by weight based on the total weight of the composition.

An object of the invention is a consumer product in the form of a liquid scent booster comprising:
an aqueous phase,
a surfactant system essentially consisting of one or more than one non-ionic surfactant, wherein the surfactant system has a mean HLB between 10 and 14, preferably chosen from the group consisting of ethoxylated aliphatic alcohols, POE/PPG (polyoxyethylene and polyoxypropylene) ethers, mono and polyglyceryl esters, sucrose ester compounds, polyoxyethylene hydroxylesters, alkyl polyglucosides, amine oxides and combinations thereof;
a linker chosen from the group consisting of alcohols, salts and esters of carboxylic acids, salts and esters of hydroxyl carboxylic acids, fatty acids, fatty acid salts, glycerol fatty acids, surfactant having an HLB less than 10 and mixtures thereof, and
a perfuming composition of matter as defined above, preferably in an amount comprised between 0.05 to 20 wt %, more preferably between 0.1 and 15 wt % by weight based on the total weight of the composition.

An object of the invention is a consumer product in the form of a shampoo or a shower gel composition comprising:
a shampoo or a shower gel active base, preferably in an amount comprised between 85 and 99.95% by weight based on the total weight of the composition,
a perfuming composition of matter as defined above, preferably in an amount comprised between 0.05 to 15 wt %, more preferably between 0.1 and 5 wt % by weight based on the total weight of the composition.

The shampoo or a shower gel active base may comprise sodium alkylether sulfate, ammonium alkylether sulfates, alkylamphoacetate, cocamidopropyl betaine, cocamide MEA, alkylglucosides and aminoacid based surfactants and mixtures thereof.

An object of the invention is a consumer product in the form of a rinse-off conditioner composition comprising:
a rinse-off conditioner active base, preferably in an amount comprised between 85 and 99.95% by weight based on the total weight of the composition,
a perfuming composition of matter as defined above, preferably in an amount comprised between 0.05 to 15 wt %, more preferably between 0.1 and 5 wt % by weight based on the total weight of the composition.

The rinse-off conditioner active base may comprise cetyltrimonium chloride, stearyl trimonium chloride, benzalkonium chloride, behentrimonium chloride and mixture thereof.

An object of the invention is a consumer product in the form of an oxidative hair coloring composition comprising:
an oxidizing phase comprising an oxidizing agent and an alkaline phase comprising an alkakine agent, a dye precursor and a coupling compound; wherein said dye precursor and said coupling compound form an oxidative hair dye in the presence of the oxidizing agent, preferably in an amount comprised between 85 and 99.95% by weight, based on the total weight of the composition,
a perfuming composition of matter as defined above, preferably in an amount comprised between 0.05 to 15 wt %, more preferably between 0.1 and 5 wt % by weight based on the total weight of the composition.

By “oxidative hair coloring composition”, it, is meant a composition comprising two groups of colorless dye molecules: the dye precursor and the coupling agent. Upon reaction with each other through an oxidation process, they form a wide range of colored molecules (dyes) that are then trapped into the hair due their size. In other words, the dye precursor and the coupling compound form an oxidative hair dye in the presence of the oxidizing agent.

“Dye precursor” and “oxidative dye precursor” are used indifferently in the present invention.

Dye precursors can be aromatic compounds derived from benzene substituted by at least two electron donor groups such as NH₂ and OH in para or ortho positions to confer the property of easy oxidation.

According to an embodiment, dye precursors are chosen from the group consisting of p-phenylene diamine, 2,5-diamino toluene, N,N-bis(2-hydroxymethyl)-p-phenylene diamine, 4-aminophenol, 1,4-diamino-benzene, and mixtures thereof.

The primary dye precursor is used in combination with coupling agents. Coupling agents are preferably aromatic compounds derived from benzene and substituted by groups such as NH₂ and OH in the meta position and do not produce color singly, but which modify the color, shade or intensity of the colors developed by the dye precursor.

According to an embodiment, the coupling agent is chosen from the group consisting of resorcinol, 2-methyl resorcinol, 4-chlororesorchinol, 2,5-diamino-toluene, 1,3-diamino-benzene, 2,4-diaminophenoxyethanol HCl, 2-amino-hydroxyethylaminoanisole sulfate, 4-amino-2-hydroxytoluene, and mixtures thereof.

The oxidative dye precursor is preferably used in an amount comprised between 0.001% and 5%, preferably between 0.1% and 4% by weight based on the total weight of the composition.

The use of oxidative dye precursors and coupling agents in hair coloring formulation have been widely disclosed in the prior art and is well-known from the person skilled in the art. One may cite for example EP 0946133A1, the content of which is incorporated by reference.

The alkaline phase comprises an alkaline agent, preferably chosen from the group consisting of ammonia hydroxide, ammonia carbonate, ethanolamine, potassium hydroxide, sodium borate, sodium carbonate, triethanolamine and mixtures thereof.

The alkaline agent is preferably used in an amount comprised between 1% and 10%, preferably between 3% and 9% by weight based on the total weight of the composition.

According to the invention, the coupling agent and the dye precursor in an alkaline medium form an oxidative hair dye in the presence of the oxidizing agent.

The oxidizing agent will supply the necessary oxygen gas to develop color molecules and create a change in hair color.

The oxidizing agent should be safe and effective for use in the compositions herein.

Preferably, the oxidizing agents suitable for use herein will be soluble in the compositions according to the present invention when in liquid form and/or in the form intended to be used.

Preferably, oxidizing agents suitable for use herein will be water-soluble. Suitable oxidizing agents for use herein are selected from inorganic peroxygen oxidizing agents, preformed organic peroxyacid oxidizing agents and organic peroxide oxidizing agents or mixtures thereof.

The oxidizing agent is preferably used in an amount comprised between 5 and 30%, preferably between 5 and 25% by weight based on the total weight of the composition.

Components commonly used in cosmetic compositions may be added into the hair coloring composition as defined in the present invention. One may cite for example, surfactants, cationic polymers, oily substances, silicone derivatives, free perfume, preservatives, ultraviolet absorbents, antioxidants, germicides, propellants, thickeners.

According to a particular embodiment, the hair coloring composition comprises one or more quaternary ammonium compounds, preferably chosen from the group consisting of cetyltrimonium chloride, stearyl trimonium chloride, benzalkonium chloride, behentrimonium chloride and mixture thereof to confer hair conditioner benefits.

Some of the above-mentioned perfumed consumer products may represent an aggressive medium for the invention's perfuming composition of matter, so that it may be necessary to protect the latter from premature decomposition, for example by encapsulation or by chemically binding it to another chemical which is suitable to release the invention's composition or part of the invention composition upon a suitable external stimulus, such as an enzyme, light, heat or a change of pH.

The proportions in which the perfuming composition of matter according to the invention can be incorporated into the various aforementioned products or compositions vary within a wide range of values. These values are dependent on the nature of the article to be perfumed and on the desired organoleptic effect as well as on the nature of the co-ingredients in a given base when the perfuming composition of matter according to the invention are mixed with perfuming co-ingredients, solvents or additives commonly used in the art.

For example, in the case of perfuming compositions, typical concentrations are in the order of 0.1% to 100% by weight, in particular in the order of 1% to 50%, in particular in the order of 1% to 20%, of the invention's perfuming composition of matter based on the weight of the perfuming composition into which they are incorporated. In the case of perfumed consumer product, typical concentrations are in the order of 0.01% to 20% by weight, or even more, of the invention's perfuming composition of matter based on the weight of the consumer product, into which they are incorporated, in particular in the order of 0.05% to 10%. Particularly, in the case of perfumed consumer product, typical concentrations of the profragrance are in the order of 0.0001% to 10% by weight, or even more, based on the weight of the consumer product into which they are incorporated, in particular, in the order of 0.001% to 5%, even more particularly, in the order of 0.1 to 1%.

The invention's perfuming composition of matter is a long lasting perfuming composition. So another object of the invention is a method for prolonging the perception of a perfume on a surface or the air surrounding the perfuming composition, wherein the surface, or the air is treated with the invention's perfuming composition of matter as defined below. The use as long lasting composition of the invention's perfuming composition of matter as defined below is another object of the invention.

Another object of the invention is a method for conferring, improving, enhancing or modifying fragrance intensity of the fragrance composition on a skin, surface or in the air surrounding of the skin or the surface over a prolonged period of time, preferably over a period of time of more than 72 hours, preferably 120 hours, preferably 250 hours, preferably 500 hours, more preferably 720 hours, under ambient conditions, wherein the method comprises the step of applying the perfuming composition of matter as defined above or the perfuming composition as defined above or the perfumed consumer product as defined above to a skin, surface or air.

For the sake of clarity, by the expression “ambient conditions”, or the similar, it is meant the normal meaning understood by a person skilled in the art, i.e. room temperature, under air and atmospheric pressure.

A further object of the invention is the use of the perfuming composition of matter as defined above or the perfuming composition as defined above or the perfumed consumer product as defined above to improve, enhance or modify the fragrance intensity of the fragrance composition on a skin, surface or in the air surrounding of the skin or the surface over a prolonged period of time, preferably over a period of time of 72 hours, preferably 120 hours, preferably 250 hours, preferably 500 hours, more preferably 720 hours, under ambient conditions

The invention will now be further described by way of examples. It will be appreciated that the invention as claimed is not intended to be limited in any way by these examples.

### EXAMPLES

The invention will now be described in further detail by way of the following examples, wherein the abbreviations have the usual meaning in the art, the temperatures are indicated in degrees centigrade (° C.).

### Example 1

### Preparation of a Perfuming Composition Comprising Perfuming Ingredient Having a Logp Above 3

Perfuming compositions of matter were prepared by admixing the following ingredients:

TABLE 1
Composition of perfuming composition

| | Perfuming composition of matter | |
|---|---|---|
| | Part by Weight | |
| Ingredients | A | B |
| (+−)-2-methylundecanal | 400 | 400 |
| 9/10-undecenal | 20 | 20 |
| (3aRS,5aSR,9aSR,9bRS)-3a,6,6,9a- | | 70 |
| tetramethyldodecahydronaphtho[2,1-b]furan and | | |
| (3aRS,5aSR,9aSR,9bSR)-3a,6,6,9a- | | |
| tetramethyldodecahydronaphtho[2,1-b]furan | | |
| 2-methylbutyl salicylate and pentyl salicylate | | 650 |
| 1-((2RS,3RS)-2,3,8,8-tetramethyl-1,2,3,4,5,6,7,8- | 665 | |
| octahydronaphthalen-2-yl)ethanone, 1-[(2RS,3RS,8aRS)-2,3,8,8- | | |
| tetramethyl-1,2,3,5,6,7,8,8a-octahydro-2-naphthalenyl]ethanone, | | |
| 1-[(2RS,3RS,8aRS)-2,3,8,8-tetramethyl-1,2,3,4,6,7,8,8a- | | |
| octahydro-2-naphthalenyl]ethanone | | |
| benzyl salicylate | | 630 |
| (3aRS,5aSR,9aSR,9bRS)-3a,6,6,9a- | 70 | |
| tetramethyldodecahydronaphtho[2,1-b]furan | | |
| (3Z)-3-hexen-1-yl salicylate | 400 | 400 |
| patchouli oil¹⁾ | 400 | |
| cyclohexyl 2-hydroxybenzoate | 650 | |
| (2E)-1-[(1RS,2SR)-2,6,6-trimethyl-3-cyclohexen-1-yl]-2-buten-1- | 275 | 275 |
| one | | |
| (1-ethoxyethoxy)cyclododecane | 75 | |
| limonene | 250 | 250 |
| 1-oxa-12/13-cyclohexadecen-2-one | 600 | 600 |
| hexyl 2-hydroxybenzoate | 630 | |
| isopropyl myristate | 200 | 570 |
| 2-methyl-3-[4-(2-methyl-2-propanyl)phenyl]propanal | 1540 | 1540 |
| 3/4-(4-methyl-3-penten-1-yl)-3-cyclohexene-1-carbaldehyde | 300 | 300 |
| orange oil | 25 | 25 |
| patchouli oil | | 400 |
| cyclohexylidene(phenyl)acetonitrile | 500 | 500 |
| tetrahydro-4-methyl-2-(2-methyl-1-propenyl)-2H-pyran | 50 | 50 |
| 1-[(1RS,2RS)-1,2,8,8-tetramethyl-1,2,3,4,5,6,7,8-octahydro-2- | | 370 |
| naphthalenyl]ethanone, 1-((2RS,3RS)-2,3,8,8-tetramethyl- | | |
| 1,2,3,4,5,6,7,8-octahydronaphthalen-2- | | |
| yl)ethanone,[(2RS,3RS,8aRS)-2,3,8,8-tetramethyl- | | |
| 1,2,3,5,6,7,8,8a-octahydro-2-naphthalenyl]ethanone, 1- | | |
| [(1RS,2RS,8aSR)-1,2,8,8-tetramethyl-1,2,3,5,6,7,8,8a-octahydro- | | |
| 2-naphthalenyl]ethanone, 1-[(2RS,3RS,8aRS)-2,3,8,8- | | |
| tetramethyl-1,2,3,4,6,7,8,8a-octahydro-2-naphthalenyl]ethanone | | |
| tricyclo[5.2.1.0~2,6~]dec-3-en-8-yl acetate and | | 750 |
| tricyclo[5.2.1.0~2,6~]dec-4-en-8-yl acetate | | |
| tricyclo[5.2.1.0(2,6)]dec-3-en-8-yl propanoate and | 750 | |
| tricyclo[5.2.1.0(2,6)]dec-4-en-8-yl propanoate | | |
| 2-methoxynaphthalene | 200 | 200 |
| TOTAL | 8000 | 8000 |

¹⁾Clearwood ®; origin: Firmenich SA, Geneva, Switzerland

### Example 2

### Sensory Evaluation of Invention's Perfuming Composition of Matter

Perfumed liquid detergents were prepared by admixing the following ingredients:

TABLE 2
Composition of the liquid detergent formulation

| | Liquid | Liquid | Liquid |
|---|---|---|---|
| | detergent 1 | detergent 2 | detergent 3 |
| Ingredients | (%) | (%) | (%) |
| Perfumed liquid | 100 | 79.72 | 99.85 |
| detergent from the market | | | |
| Unperfumed liquid | 0 | 19.93 | 0 |
| detergent | | | |
| Perfume of | 0 | 0.2 | 0 |
| Example 1 A | | | |
| 3-(dodecylthio)-1- | 0 | 0.1 | 0.1 |
| (2,6,6-trimethyl-3- | | | |
| cyclohexen-1-yl)-1- | | | |
| butanone | | | |
| Mixture comprising | 0 | 0.05 | 0.05 |
| 4-(dodecylthio)-4-(2,6,6- | | | |
| trimethyl-2-cyclohexen- | | | |
| 1-yl)-2-butanone and 4- | | | |
| (dodecylthio)-4-(2,6,6- | | | |
| trimethyl-1-cyclohexen- | | | |
| 1-yl)-2-butanone in a | | | |
| 55:45 ratio | | | |

Fabrics (1.7 kg of 30*cotton terry towels) were washed at 35° C. in standard American top loader machine. There were dispensed 60 g of liquid detergent as reported above at the start of the wash. After the washing cycle is finished the fabrics were tumble-dried for 45 minutes before the odor of the cotton towels was evaluated by a panel of 50 panelists. The panelists were asked to rate the the long lasting freshness.

95% of the panelist assessed Liquid detergent 2, corresponding to the invention, as the one imparting the best long lasting freshness.

### Example 3

### Preparation of a Ganulated PEG Base Comprising the Invention's Composition of Matter

TABLE 3
Composition of the granulated PEG base

| | Bead 1 | Bead 2 | Bead 3 | Bead 4 | Bead 5 |
|---|---|---|---|---|---|
| Ingredients | (%) | (%) | (%) | (%) | (%) |
| PEG 4000 - 7500 | 65 | 70.8 | 70.8 | 64.86 | 64.86 |
| Dextrose | 27 | 29 | 29 | 26.94 | 26.94 |
| Perfume of | 8 | 0 | 0 | 8 | 8 |
| Example 1 A | | | | | |
| 3-(dodecylthio)-1- | 0 | 0.2 | 0.133 | 0.2 | 0.133 |
| (2,6,6-trimethyl-3- | | | | | |
| cyclohexen-1-y1)-1- | | | | | |
| butanone | | | | | |
| Mixture comprising | 0 | 0 | 0.066 | 0 | 0.066 |
| 4-(dodecylthio)-4-(2,6,6- | | | | | |
| trimethyl-2-cyclohexen- | | | | | |
| 1-yl)-2-butanone and 4- | | | | | |
| (dodecylthio)-4-(2,6,6- | | | | | |
| trimethyl-1-cyclohexen- | | | | | |
| 1-yl)-2-butanone in a | | | | | |
| 55:45 ratio | | | | | |

1) DETE-2624 Alkaline Lipase for detergent, powder form, from creative Enzyme

To the PEG base, dextrose were added and the mixture was melted at 80° C. Then perfuming composition of Example 1 and/or 3-(dodecylthio)-1-(2,6,6-trimethyl-3-cyclohexen-1-yl)-1-butanone and/or mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio were added. The mixture was then pelletized while cooling, by pouring a thin film of the molten mixture onto a flat surface, and cutting it in smaller pieces after solidification.

### Example 4

### Preparation of a Softener Formulation Comprising the Invention's Composition of Matter

A typical unperfumed softener formulation is listed in Table 4. The unperfumed softener was prepared by weighting Methyl bis[ethyl (tallowate)]-2-hydroxyethyl ammonium methyl sulfate which was heated at 65° C. Then, Water and 1,2-benzisothiazolin-3-one were placed in the reactor and were heated at 65° C. under stirring. To the above mixture was added Methyl bis[ethyl (tallowate)]-2-hydroxyethyl ammonium methyl sulfate. The mixture was stirred 15 minutes and CaCl₂ was added.

TABLE 4
Composition of a typical unperfumed softener formulation.

| Ingredients | Amount (% wt) | Function |
|---|---|---|
| Methyl bis[ethyl(tallowate)]-2- | 12.2 | Softening agent |
| hydroxyethyl ammonium | | |
| methyl sulfate¹⁾ | | |
| Calcium chloride sol 10% | 0.4 | Viscosity modifier |
| 1,2-benzisothiazolin-3-one²⁾ | 0.04 | Preservative |
| Water | 87.36 | |

¹⁾Stepantex ® VL 90A- Stepan
²⁾Proxel ® GXL - Arch

The perfumed softener formulation is then obtained by adding, under gentle shaking, a perfumed composition of Example 1 (0. 05 to 1.5% by weight relative to the total weight of the unperfumed softener formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 2% by weight relative to the total weight of the unperfumed softener formulation) into the unperfumed softener formulation listed in Table 4.

### Example 5

### Preparation of Transparent Isotropic Shampoo Formulations Comprising Invention's Perfumed Composition

A typical unperfumed transparent isotropic shampoo formulation is listed in Table 5. The unperfumed shampoo formulation is prepared by dispersing Polyquaternium-10 in water. The remaining ingredients of Phase A are mixed separately by addition of one after the other while mixing well after each adjunction. This pre-mix is added to the Polyquaternium-dispersion and mixed for another 5 min. Then, the premixed Phase B and the premixed Phase C are added (Monomuls® 90L-12 is heated to melt in Texapon® NSO IS) while agitating. Phase D and Phase E are added while agitating. The pH is adjusted with a citric acid solution to 5.5-6.0.

TABLE 5
Composition of a typical unperfumed transparent
isotropic shampoo formulation.

| Phase | Ingredients | Amount [wt %] |
|---|---|---|
| A | Deionized water | 44.4 |
| | Polyquaternium-10 ⁽¹⁾ | 0.3 |
| | Glycerin 85% ⁽²⁾ | 1.0 |
| | DMDM Hydantoin ⁽³⁾ | 0.2 |
| B | Sodium laureth sulfate ⁽⁴⁾ | 28.0 |
| | Cocamidopropyl betaine ⁽⁵⁾ | 3.2 |
| | Disodium cocoamphodiacetate ⁽⁶⁾ | 4.0 |
| | Ethoxy (20) stearyl alcohol ⁽⁷⁾ | 1.0 |
| C | Sodium laureth sulfate ⁽⁴⁾ | 3.0 |
| | Glyceryl laureate ⁽⁸⁾ | 0.2 |
| D | Deionized water | 1.0 |
| | Sodium methylparaben ⁽⁹⁾ | 0.1 |
| E | Sodium chloride (10% aqueous solution) | 15.0 |
| | Citric acid (10% aqueous solution to pH 5.5-6.0) | q.s. |

⁽¹⁾ Ucare ® Polymer JR-400; origin: Noveon
⁽²⁾ Origin: Brenntag Schweizerhall AG
⁽³⁾ Glydant ®; origin: Lonza
⁽⁴⁾ Texapon ® NSO IS; origin: Cognis
⁽⁵⁾ Tego ® Betain F 50; origin: Evonik
⁽⁶⁾ Amphotensid GB 2009; origin: Zschimmer & Schwarz
⁽⁷⁾ Brij ® S20; origin: Croda
⁽⁸⁾ Monomuls ® 90 L-12; origin: Gruenau GmbH
⁽⁹⁾ Nipagin Monosodium; origin: NIPA

The perfumed shampoo formulation is then obtained by adding, under gentle shaking, a perfumed composition of Example 1 (0.05 to 1.3% by weight relative to the total weight of the unperfumed shampoo formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) into the unperfumed shampoo formulation listed in Table 5. 76

### Example 6

### Preparation of Pearly Shampoo Formulations Comprising Invention's Perfumed Composition

A typical unperfumed pearly shampoo formulation is listed in Table 6. The unperfumed shampoo formulation is prepared by dispersing Tetrasodium EDTA, Guar hydroxypropyltrimonium chloride and Polyquaternium-10 in water. NaOH (10% aqueous solution, Phase B) is added once Phase A is homogeneous. Then, the premixed Phase C is added, and the mixture heated to 75° C. Phase D ingredients are added and mixed until the mixture is homogeneous. The mixture is cooled. At 45° C., Phase E ingredients are added while mixing. The final viscosity is adjusted with NaCl (25% aqueous solution) and a pH of 5.5-6.0 is adjusted with NaOH (10% aqueous solution).

TABLE 6
Composition of a typical pearly shampoo formulation.

| | | Amount |
|---|---|---|
| Phase | Ingredients | [wt %] |
| A | Deionized water | 45.97 |
| | Tetrasodium EDTA ⁽¹⁾ | 0.05 |
| | Guar hydroxypropyl-trimonium chloride ⁽²⁾ | 0.05 |
| | Polyquaternium-10 ⁽³⁾ | 0.075 |
| B | NaOH (10% aqueous solution) | 0.30 |
| C | Ammonium lauryl sulfate ⁽⁴⁾ | 34.00 |
| | Ammonium laureth sulfate ⁽⁵⁾ | 9.25 |
| | Cocamidopropyl betaine ⁽⁶⁾ | 2.00 |
| | Dimethicone (&) C₁₂₋₁₃ pareth-4 (&) C₁₂₋₁₃ pareth-23 | 2.50 |
| | (&) salicylic acid ⁽⁷⁾ | |
| D | Cetyl alcohol ⁽⁸⁾ | 1.20 |
| | Cocamide MEA ⁽⁹⁾ | 1.50 |
| | Glycol distearate ⁽¹⁰⁾ | 2.00 |
| E | Methylchloroisothiazolinone & | 0.10 |
| | methylisothiazolinone ⁽¹¹⁾ | |
| | D-Panthenol 75% ⁽¹²⁾ | 0.10 |
| | Deionized water | 0.30 |
| F | Sodium chloride (25% aqueous solution) | 0.60 |

⁽¹⁾ EDETA ® B Powder; origin: BASF
⁽²⁾ Jaguar ® C14 S; origin: Rhodia
⁽³⁾ Ucare ® Polymer JR-400; origin: Noveon
⁽⁴⁾ Sulfetal ® LA B-E; origin: Zschimmer & Schwarz
⁽⁵⁾ Zetesol ® LA; origin: Zschimmer & Schwarz
⁽⁶⁾ Tego ® Betain F 50; origin: Evonik
⁽⁷⁾ Xiameter ® MEM-1691; origin: Dow Corning
⁽⁸⁾ Lanette ® 16; origin: BASF
⁽⁹⁾ Comperlan ® 100; origin: Cognis
⁽¹⁰⁾ Cutina ® AGS; origin: Cognis
⁽¹¹⁾ Kathon ® CG; origin: Rohm & Haas
⁽¹²⁾ D-Panthenol; origin: Roche

A perfumed pearly shampoo formulation is then obtained by adding, under gentle shaking, a perfumed composition of Example 1 to 3 (0.05 to 1.3% by weight relative to the total weight of the unperfumed shampoo formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and 20 a mixture thereof (0.05 to 1% by weight relative to the total weight of the unperfumed softener formulation) into the unperfumed pearly shampoo formulation listed in Table 6.

### Example 7

### Preparation of Rinse-Off Hair Conditioner Formulations Comprising an Invention's Perfumed Composition

A typical unperfumed rinse-off hair conditioner formulation is listed in Table 7. The unperfumed rinse-off hair conditioner formulation is prepared by mixing the ingredients of Phase A until an uniform mixture was obtained. Tyloses is allowed to completely dissolve. Then the mixture is heated to 70-75° C. The ingredients of Phase B are combined and melted at 70-75° C. Then the ingredients of Phase B are added to Phase A with good agitation, and the mixing is continued until that the mixture has a temperature of 60° C. Then, the ingredients of Phase C are added while agitating and keeping mixing until the mixture cooled to 40° C. The pH is adjusted with a citric acid solution to 3.5-4.0.

TABLE 7
Composition of a typical rinse-off hair conditioner formulation.

| | | Amount |
|---|---|---|
| Phase | Ingredients | [wt %] |
| A | Deionized water | 81.8 |
| | Behentrimonium chloride ⁽¹⁾ | 2.5 |
| | Hydroxyethylcellulose ⁽²⁾ | 1.5 |
| B | Cetearyl alcohol ⁽³⁾ | 4.0 |
| | Glyceryl stearate (and) PEG-100 stearate ⁽⁴⁾ | 2.0 |
| | Behentrimonium metho-sulfate (and) cetyl alcohol (and) | 4.0 |
| | butylene glycol ⁽⁵⁾ | |
| | Ethoxy (20) stearyl alcohol ⁽⁶⁾ | 1.0 |
| C | Amodimethicone (and) Trideceth-12 (and) Cetrimonium | 3.0 |
| | chloride ⁽⁷⁾ | |
| | Chlorhexidine digluconate (20% aqueous solution) ⁽⁸⁾ | 0.2 |
| D | Citric acid (10% aqueous solution tol pH 3.5-4.0) | q.s |

⁽¹⁾ Genamin ® KDMP; origin: Clariant
⁽²⁾ Tylose ® H10 Y G4; origin: Shin Etsu
⁽³⁾ Lanette ® O; origin: BASF
⁽⁴⁾ Arlacel ® 165; origin: Croda
⁽⁵⁾ Incroquat ® Behenyl TMS-50-PA- (MH); origin: Croda
⁽⁶⁾ Brij ® S20; origin: Croda
⁽⁷⁾ Xiameter ® MEM-949; origin: Dow Corning
⁽⁸⁾ Origin: Alfa Aesar

A perfumed rinse-off hair conditioner formulation is then obtained by adding, under gentle shaking, a perfumed composition of Example 1 (0.05 to 1.5% by weight relative to the total weight of the unperfumed conditioner formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight, of the unperfumed softener formulation) into the unperfumed rinse-off hair conditioner formulation listed in Table 7.

### Example 8

### Preparation of Structured Shower Gel Formulations Comprising an Invention's Perfumed Composition

A typical unperfumed structured shower gel formulation is listed in Table 8. A perfumed structured shower gel is prepared by adding, under gentle shaking, a perfumed composition of Example 1 (0.05 to 2% by weight relative to the total weight of the structured shower gel) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) into the unperfumed structured shower gel formulation of Table 8.

TABLE 8
Composition of a typical unperfumed
structured shower gel formulation.

| | Amount |
|---|---|
| Ingredients | [wt %] |
| Deionized water | 49.35 |
| Tetrasodium EDTA ⁽¹⁾ | 0.05 |
| Acrylates co-polymer ⁽²⁾ | 6.00 |
| Sodium C₁₂₋₁₅ pareth sulfate ⁽³⁾ | 35.00 |
| Sodium hydroxide (20% aqueous solution) | 1.00 |
| Cocamidopropyl betaine ⁽⁴⁾ | 8.00 |
| Methylchloroisothiazolinone and methylisothiazolinone ⁽⁵⁾ | 0.10 |
| Citric acid (40% aqueous solution) | 0.50 |

⁽¹⁾ EDETA B powder; origin: BASF
⁽²⁾ Carbopol Aqua SF-1 polymer; origin: Noveon
⁽³⁾ Zetesol AO 328 U; origin: Zschimmer & Schwarz
⁽⁴⁾ Tego Betain F 50; origin: Goldschmidt
⁽⁵⁾ Kathon ® CG; origin: Rohm & Haas

### Example 9

### Preparation of Transparent Shower Gel Formulations Comprising an Invention's Perfumed Composition

A typical unperfumed transparent shower gel formulation is listed in Table 9. A perfumed transparent shower gel is prepared by adding, under gentle shaking, a perfumed composition of Example 1 (0.05 to 2% by weight relative to the total weight of the transparent shower gel) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight, of the unperfumed softener formulation) into the unperfumed transparent shower gel formulation of Table 9.

TABLE 9
Composition of a typical unperfumed
transparent shower gel formulation

| Ingredients | Amount [wt %] |
|---|---|
| Deionized water | 52.40 |
| Tetrasodium EDTA ⁽¹⁾ | 0.10 |
| Sodium benzoate | 0.50 |
| Propylene glycol | 2.00 |
| Sodium C₁₂₋₁₅ pareth sulfate ⁽²⁾ | 35.00 |
| Cocamidopropyl betaine ⁽³⁾ | 8.00 |
| Polyquaternium-7 ⁽⁴⁾ | 0.20 |
| Citric acid (40% aqueous solution) | 1.00 |
| Sodium chloride | 0.80 |

⁽¹⁾ EDETA B powder; origin: BASF
⁽²⁾ Zetesol AO 328 U; origin: Zschimmer & Schwarz
⁽³⁾ Tego Betain F 50; origin: Goldschmidt
⁽⁴⁾ Merquat ® 550; origin: Lubrizol

### Example 10

### Preparation of Milky Shower Gel Formulations Comprising an Invention's Perfumed Composition

A typical unperfumed milky shower gel formulation is listed in Table 10. A perfumed milky shower gel is prepared by adding, under gentle shaking, a perfumed composition of Example 1 (0.05 to 2% by weight relative to the total weight, of the milky shower gel) and at least one profragrance selected from the group of 3-(dodecylthio)-1-(2,6,6-trimethyl-3-cyclohexen-1-yl)-1-butanone. a mixture comprising 4-(dodecylthio)-4-(2,6,6-trimethyl-2-cyclohexen-1-yl)-2-butanone and 4-(dodecy lthio)-4-(2,6,6-trimethyl-1-cyclohexen-1-yl)-2-butanone in a 55:45 ratio and a mixture thereof (0.05 to 1% by weight relative to the total weight of the unperfumed softener formulation) into the unperfumed milky shower gel formulation of Table 10.

TABLE 10
Composition of a typical unperfumed
milky shower gel formulation.

| | Amount |
|---|---|
| Ingredients | [wt %] |
| Deionized water | 50.95 |
| Tetrasodium EDTA ⁽¹⁾ | 0.05 |
| Sodium benzoate | 0.50 |
| Glycerin (86% aqueous solution) | 3.50 |
| Sodium laureth sulfate ⁽²⁾ | 27.00 |
| Polyquaternium-7 ⁽³⁾ | 1.00 |
| Coco-betaine ⁽⁴⁾ | 6.00 |
| PEG-120 Methyl glucose trioleate ⁽⁵⁾ | 1.00 |
| Citric acid (40% aqueous solution) | 1.00 |
| Glycol distearate & laureth-4 & cocamidopropyl betaine ⁽⁶⁾ | 3.00 |
| Sodium chloride (20% aqueous solution) | 5.00 |
| PEG-40 hydrogenated castor oil ⁽⁷⁾ | 1.00 |

⁽¹⁾ EDETA ® B powder; origin: BASF
⁽²⁾ Texapon ® NSO IS; origin: Cognis
⁽³⁾ Merquat ® 550; origin: Lubrizol
⁽⁴⁾ Dehyton ® AB-30; origin: Cognis
⁽⁵⁾ Glucamate ® LT; origin: Lubrizol
⁽⁶⁾ Euperlan ® PK 3000 AM; origin: Cognis
⁽⁷⁾ Cremophor ® RH 40; origin: BASF

### Example 11

### Preparation of Anhydrous Antiperspirant Spra Formulations Comprising an Invention's Perfumed Composition

A typical unperfumed anhydrous antiperspirant spray formulation is listed in Table 11. The anhydrous antiperspirant spray formulation is prepared by using a high-speed stirrer. Silica and Quaternium-18-hectorite are added to the mixture of isopropyl myristate and cyclomethicone. Once completely swollen, aluminium chlorohydrate is added portion-wise under stirring until the mixture becomes homogeneous and without lumps.

TABLE 11
Composition of a typical unperfumed
anhydrous antiperspirant spray.

| Ingredients | Amount [wt %] |
|---|---|
| Cyclomethicone ⁽¹⁾ | 53.51 |
| Isopropyl myristate | 9.04 |
| Silica ⁽²⁾ | 1.03 |
| Quaternium-18-hectorite ⁽³⁾ | 3.36 |
| Aluminium chlorohydrate ⁽⁴⁾ | 33.06 |

⁽¹⁾ Dow Corning ® 345 Fluid; origin: Dow Corning
⁽²⁾ Aerosil ® 200; origin: Evonik
⁽³⁾ Bentone ® 38; origin: Elementis Specialities
⁽⁴⁾ Micro Dry Ultrafine; origin: Reheis

The perfumed formulation is then obtained by adding a perfumed composition of Example (0.05 to 2% by weight relative to the total weight of the antiperspirant spray formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl -1-c yclohexen-1-yl)-2-butanone in a 55:45 ratio and a mixture thereof (0.05 to 1% by weight relative to the total weight of the unperfumed softener formulation) into the unperfumed antiperspirant spray formulation of Table 11.

The aerosol cans were filled with 25% Suspension of the suspension and 75% of Propane/Butane (2,5 bar).

### Example 12

### Preparation of Deodorant Spray Emulsion Formulations Comprising an Invention's Perfumed Composition

A typical deodorant spray emulsion formulation is prepared by mixing and dissolving all the ingredients according to the sequence of Table 12. Then a perfumed composition of Example 1 (0.05 to 2% by weight relative to the total weight of the deodorant spray formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) are added under gentle shaking. Then aerosol cans are filled, and the propellant is crimped and added. Aerosol filling: 40% active solution 60% propane/butane (2.5 bar).

TABLE 12
Composition of a typical unperfumed deodorant spray formulation.

| Ingredients | Amount [wt %] |
|---|---|
| Ethanol (95%) | 90.65 |
| Triclosan ⁽¹⁾ | 0.26 |
| Isopropyl myristate | 9.09 |

⁽¹⁾ Irgasan ® DP 300; origin: BASF

### Example 13

### Preparation of Deodorant Stick Formulations Comprising an Invention's Perfumed Composition

A typical unperfumed deodorant stick formulation is listed in Table 13. The deodorant stick formulation is obtained by weighing all the components of Part A and heating to 70-75° C. Ceteareth-25 is added once the other Part A ingredients are mixed and heated. Once the Ceteareth-25 is dissolved, stearic acid is added. Part B is prepared by dissolving Triclosan in 1,2-propylene glycol. Evaporated water is compensated. Then, slowly, under mixing, Part B is poured into Part A.

TABLE 13
Composition of a typical unperfumed deodorant stick formulation.

| Phase | Ingredients | Amount [wt %] |
|---|---|---|
| A | Stearic acid | 5.05 |
| | 1,2-Propylene glycol | 41.87 |
| | Sodium hydroxide (20% aqueous solution) | 4.24 |
| | Water | 30.30 |
| | Tetrasodium EDTA ⁽¹⁾ | 0.10 |
| | Ceteareth-25 ⁽²⁾ | 1.52 |
| | PPG-3 Myristyl ether ⁽³⁾ | 1.52 |
| B | 1,2-Propylene glycol | 15.14 |
| | Triclosan ⁽⁴⁾ | 0.25 |

⁽¹⁾ Edeta ® B Power; origin: BASF
⁽²⁾ Cremophor ® A25; origin: BASF
⁽³⁾ Tegosoft ® APM; origin: Evonik
⁽⁴⁾ Irgasan ® DP 300; origin: BASF

The perfumed deodorant stick formulation is then obtained by adding a perfumed composition of Example 1 (0.05 to 2% by weight relative to the total weight, of the deodorant stick formulation) and at least, one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight, of the unperfumed softener formulation) under gentle shaking. To stock, a plastic bag is put into the bucket to be sealed after cooling. Moulds were filled at about 70° C.

### Example 14

### Preparation of Deodorant Roll-On Formulations Comprising an Invention's Perfumed Composition

A typical unperfumed deodorant roll-on formulation is listed in Table 14. Part A is prepared by sprinkling little-by-little the hydroxyethylcellulose into the water, whilst rapidly stirring with a turbine until the hydroxyethylcellulose is entirely swollen giving a limpid gel. Part B is slowly poured into Part A, whilst continuing stirring until the entire mixture is homogeneous. Then Part C is added.

TABLE 14
Composition of a typical unperfumed
deodorant roll-on formulation.

| Phase | Ingredients | Amount [wt %] |
|---|---|---|
| A | Water | 50.51 |
| | Hydroxyethylcellulose ⁽¹⁾ | 0.71 |
| B | Ethanol (95%) | 40.40 |
| | 1,2-Propylene glycol | 5.05 |
| | Triclosan ⁽²⁾ | 0.30 |
| C | PEG-40 hydrogenated castor oil ⁽³⁾ | 3.03 |

⁽¹⁾ Natrosol ® 250 H; origin: Ashland
⁽²⁾ Irgasan ® DP 300; origin: BASF
⁽³⁾ Cremophor ® RH 40; origin: BASF

The perfumed deodorant roll-on formulation is then obtained by adding a perfumed composition of Example 1 (0.05 to 2% by weight relative to the total weight of the deodorant stick formulation) and at least one profragrance selected from the group of 3-(dodecylthio)-1-(2,6,6-tri methyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight, of the unperfumed softener formulation) under gentle shaking.

### Example 15

### Preparation of Day Cream Base O/W Emulsions Comprising an Invention's Perfumed Composition

A typical day cream base 0/W emulsion formulation is listed in Table 15. Phases A and B are heated separately to 70-75° C., then Phase A is added to Phase B and vacuum is applied. The mixture is stirred and cooled to 55° C. for 15 min. After cooling to room temperature, phenoxyethanol (and) piroctone olamine (Phase C) are added when a temperature of 45° C. is reached. The mixture is stirred for 5 min before sodium carbomer (Phase D), a perfumed composition of Example 1 (Phase E) are added. The mixture is stirred for 3 min, then the stirring was stopped for 15 min. When the temperature of the mixture reaches 30° C., the stirring is resumed for another 15 min until the cream becomes homogeneous, glossy and without lumps. If necessary the pH is adjusted to 6.70-7.20 with Glydant®, Phenoni® p or Nipaguard® PO5 or to 6.30-7.00 with Nikkoguard®.

TABLE 15
Composition of a typical day cream base O/W emulsion.

| | | Amount |
|---|---|---|
| Phase | Ingredients | [wt %] |
| A | Steareth-2 (and) PEG-8 Distearate⁽¹⁾ | 5.0 |
| | Cetyl alcohol | 0.5 |
| | Ceteth-20 (and) glyceryl stearate (and) PEG-6 stearate | 4.0 |
| | (and) Steareth-20 ⁽²⁾ | |
| | Squalan ⁽³⁾ | 1.0 |
| | Paraffin oil ⁽⁴⁾ | 2.0 |
| | Petrolatum ⁽⁵⁾ | 5.5 |
| B | Deionized water | 75.9 |
| | Propylene glycol | 5.0 |
| C | Phenoxyethanol (and) Piroctone olamine ⁽⁶⁾ | 0.6 |
| D | Sodium carbomer ⁽⁷⁾ | 0.2 |
| E | Perfumed composition of Example 1 | 0.05 to 2 |
| | 3-(dodecylthio)-1-(2,6,6-trimethyl-3-cyclohexen-1-yl)- | 0.05 to 1 |
| | 1-butanone | |

⁽¹⁾Arlacel ® 985; origin: Croda
⁽²⁾ Tefose ® 2561; origin: Gattefossé
⁽³⁾ Biolip P 90; origin: Gattefoss\acute{é}
⁽⁴⁾ Mineral oil 30-40 CPS
⁽⁵⁾ Petroleum jelly
⁽⁶⁾ Nipaguard ® PO 5; origin: Clariant
⁽⁷⁾ PNC 400

### Example 16

### Preparation of Hand Dishwash Formulations Comprising an Invention'S Perfumed Composition

A typical unperfumed hand dishwash formulation is listed in Table 16. The unperfumed hand dishwash is prepared by mixing water with sodium hydroxide and diethanolamide. Then the linear alkylbenzene sulfonic acid is added. After neutralizing, the remaining ingredients are added and the pH is adjusted to 7-8 if necessary.

TABLE 16
Composition of a typical unperfumed hand dishwash formulation.

| Ingredients | Amount [wt %] |
|---|---|
| Linear alkylbenzene sulfonic acid ⁽¹⁾ | 20.0 |
| Diethanolamide ⁽²⁾ | 3.5 |
| Sodium hydroxide (50%) ⁽³⁾ | 3.4 |
| Secondary alcohol ethoxolate ⁽⁴⁾ | 2.5 |
| Sodium xylene sulfonate | 6.3 |
| Water | 64.3 |

⁽¹⁾ Biosoft ® S-118; origin: Stepan
⁽²⁾ Ninol ® 40-CO; origin: Stepan
⁽³⁾ Stepanate ® SXS; origin: Stepan
⁽⁴⁾ Tergitol ® 15-S-9; origin: Dow Chemicals

The perfumed hand dishwash formulation is then obtained by adding a perfumed composition of Example 1 (0.05 to 2% by weight relative to the total weight of the hand dishwash formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) under gentle shaking into the unperfumed hand dishwash formulation of Table 16.

### Example 17

### Preparation of an All-Purpose Hard Surface Cleaner Formulations Comprising an Invention's Perfumed Composition

The unperfumed all-purpose hard surface cleaner is prepared by mixing ingredients listed below:

| | |
|---|---|
| Neodol ® 91-8 (origin: Shell Chemicals) | 5.0% by weight |
| Marlon ® A 375 (origin: Hüls AG) | 4.0% by weight |
| Sodium cumolsulphonate | 2.0% by weight |
| Kathon ® CG (origin: Rohm and Haas) | 0.2% by weight |
| Deionized water | 88.8% by weight |

The perfumed all-purpose hard surface cleaner formulation is then obtained by adding a perfumed composition of Example 1 (0.05 to 2% by weight, relative to the total weight of the all-purpose hard surface cleaner formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) under gentle shaking into the unperfumed all-purpose hard surface cleaner formulation mentioned above.

### Example 18

### Preparation of Powder Detergent Formulations Comprising an Invention's Perfumed Composition

A typical unperfumed powder detergent formulation comprises sodium sulfate, sodium carbonate, sodium dodecylbenzensulfonate, sodium silicate, zeolite, C₁₂₋₁₅ pareth-7, bentonite, citric acid, Sodium Acrylic Acid/MA Copolymer, sodium carbonate peroxide, tetrasodium etidronate, sodium chloride, sodium bicarbonate, cellulose gum, Disodium Anil inomorpholinotriazinylaminostilbenesulfonate, Phenylpropyl Dimethicone, enzyme, dye. The base with bleach contained the same as above plus the following additional ingredients: perborate & TAED. The concentrations of each ingredient are indicated in Table 17.

TABLE 17
Typical ranges of ingredients comprised in powder detergent:

| Ingredient | % for bleach formulation |
|---|---|
| Anionic surfactant | 5-25% |
| Non ionic surfactant | 2-15% |
| Builder: | 20-50% |
| Percarborate | 5-20% |
| TAED | 1-8% |
| Polymer | 3-10% |
| Optical brightener | 0.1-0.5% |
| Enzyme, Dye | <2% |

The perfumed powder detergent formulation is then obtained by adding a perfumed composition of Example 1 (0.05 to 2% by weight relative to the total weight of the powder detergent formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) under gentle shaking into the unperfumed powder detergent as indicated above.

### Example 19

### Preparation of Bleach-Free Powder Detergent Formulations Comprising an Invention's Perfumed Composition

A typical unperfumed bleach-free powder detergent formulation comprises sodium sulfate, sodium carbonate, sodium dodecylbenzensulfonate, sodium silicate, zeolite, C₁₂₋₁₅ pareth-7, bentonite, citric acid, Sodium Acrylic Acid/MA Copolymer, sodium carbonate peroxide, tetrasodium etidronate, sodium chloride, sodium bicarbonate, cellulose gum, Disodium Anil inomorpholinotriazinylaminostilbenesulfonate, Phenylpropyl Dimethicone, enzyme, dye. The concentrations of each ingredient are indicated in Table 18.

TABLE 18
Typical ranges of ingredients comprised in powder detergent:

| Ingredient | % for bleach formulation |
|---|---|
| Anionic surfactant | 5-25% |
| Non ionic surfactant | 2-15% |
| Builder: | 20-50% |
| Percarborate | 5-20% |
| TAED | 1-8% |
| Polymer | 3-10% |
| Optical brightener | 0.1-0.5% |
| Enzyme, Dye | <2% |

The perfumed bleach-free powder detergent formulation is then obtained by adding a perfumed composition of Example 1 (0.05 to 2% by weight relative to the total weight of the bleach-free powder detergent formulation) and at least one profragrance selected from the group of 3-(dodecylthio)-1-(2,6,6-trimethyl-3-cyclohexen-1-yl)-1-butanone, a mixture comprising 4-(dodecylthio)-4-(2,6,6-trimethyl-2-cyclohexen-1-yl)-2-butanone and 4-(dodecylthio)-4-(2,6,6-trimethyl-1-cyclohexen-1-yl)-2-butanone in a 55:45 ratio and a mixture thereof (0.05 to 1% by weight relative to the total weight of the unperfumed softener formulation) under gentle shaking into the unperfumed powder detergent as indicated above.

1. A perfuming composition of matter comprising
a) at least one profragrance compound;
b) at least one perfuming ingredient having a LogP above 3.

2. The perfuming composition of matter according to claim 1, wherein the at least one profragrance releases a perfume raw material upon exposure to air/oxygen or enzymes.

3. The perfuming composition of matter according to claim 1, wherein at least one profragrance is a compound of formula 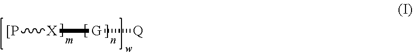
wherein:
a) w represents an integer from 1 to 10000;
b) n represents 1 or 0;
c) m represents an integer from 1 to 6;
d) P represents a hydrogen atom or a radical susceptible of generating an odoriferous α,β-unsaturated ketone, aldehyde or carboxylic ester and is represented by the formula 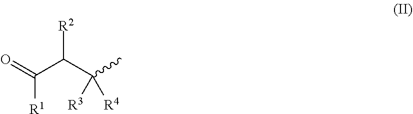
in which the wavy line indicates the location of the bond between said P and X;
R¹ represents a hydrogen atom, a C₁ to C₆ alkoxyl radical or a C₁ to C₁₅ linear, cyclic or branched alkyl, alkenyl or alkadienyl radical, optionally substituted by one to four C₁ to C₄ alkyl groups; and
R², R³ and R⁴ represent independently of each other a hydrogen atom, an aromatic ring, or a C₁ to C₁₅ linear, cyclic or branched alkyl, alkenyl or alkadienyl radical, optionally substituted by C₁ to C₄ alkyl groups; or two, or three, of the groups le to R⁴ are bonded together to form a saturated or unsaturated ring having 5 to 20 carbon atoms and including the carbon atom to which said R¹, R², R³ or R⁴ groups are bonded, this ring being optionally substituted by C₁ to C₈ linear, branched or cyclic alkyl or alkenyl groups; and with the proviso that at least one of the P groups is of the formula (II) as defined hereinabove;
e) X represents, independently from each other, a functional group selected from the group consisting of the formulae i) to xiv): 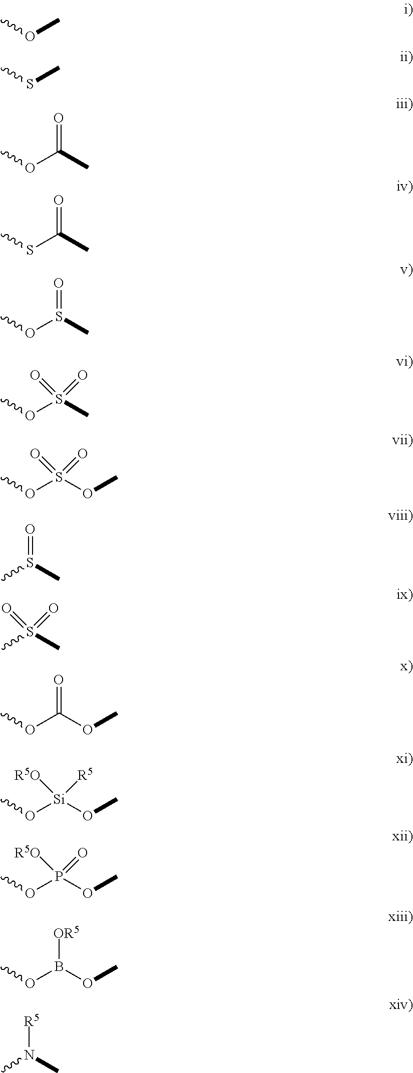
in which formulae the wavy lines are as defined previously and the bold lines indicate the location of the bond between said X and G, and R⁵ represents a hydrogen atom, a C₁ to C₂₂, saturated or unsaturated, alkyl group or an aryl group, optionally substituted by C₁ to C₆ alkyl or alkoxyl groups or halogen atoms; and with the proviso that X may not exist when P represents a hydrogen atom;
f) G represents a multivalent radical (with a m+1 valence) derived from cyclic, linear, alicyclic or branched alkyl, cyclic, linear, alicyclic or branched alkenyl, phenyl, alkylphenyl or alkenylphenyl hydrocarbon radical having from 1 to 22 carbon atoms, said hydrocarbon radical being optionally substituted and containing from 1 to 10 functional groups selected from the group consisting of halogens, alcohols, ethers, esters, ketones, aldehydes, carboxylic acids, thiols, thioethers, amines, quaternary amines and amides; and
g) Q represents a hydrogen atom (in which case w=1 and n=1), or represents a polymer or co-polymer selected from the group consisting of poly(alkylimine)s, polypeptides (e.g. polylysine) or polysaccharides selected from the group consisting of cellulose, cyclodextrins and starches, or cationic quaternized silicon polymers, or still a polymer or random co-polymer derived from monomeric units selected from the group consisting of the formulae A-1), A-2), A-3), B-1), B-2), C-1), C-2), and C-3): 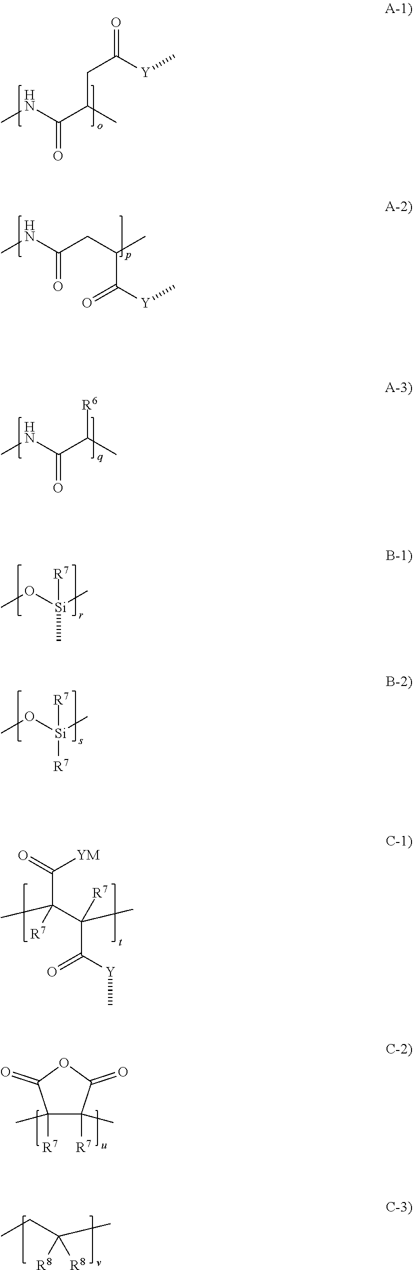
wherein the hatched lines indicate the location of the bond between said monomeric unit and G;
Y represents an oxygen or sulfur atom or a NR' group;
o, p, q, r, s, t, u and v all represent independent of each other fractions between 0 and 1, with o+p+q=1, r+s=1 and t+u+v=1 and with the proviso that either o or p, as well as r and t are not equal to 0;
R⁶ represents a hydrogen atom or a side chain from a natural or unnatural amino acid, such as glycine, alanine, phenylalanine, arginine, histidine, lysine, aspartic acid, glutamic acid, cysteine, methionine, glutamine, asparagine, threonine, serine, leucine, isoleucine, valine, tyrosine or tryptophan;
R⁷ represents, simultaneously or independently, a hydrogen atom or a C₁-₁₆ hydrocarbon group;
R⁸ represents, simultaneously or independently of each other
a hydrogen or halide atom;
a C₁-C₆ hydrocarbon group optionally comprising from 1 to 4 heteroatoms selected from the group consisting of oxygen and sulfur atoms;
a carboxylic group of formula COOR*, wherein R* represents a hydrogen atom, a C₁-C₆₀ alkyl or alkenyl group optionally comprising from 1 to 30 oxygen atoms;
a OR' group or a COR' group; or
a pyrrolidone unit, connected by the nitrogen atom; and
M represents a hydrogen atom, an alkali or earth alkali metal ion.

4. The perfuming composition of matter according to claim 1, wherein the at least one profragrance is a compound of formula 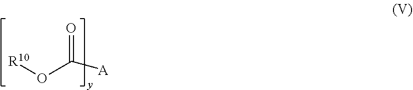
wherein y is either 1 or 2; A is an y-valent C₁₋₂₂ hydrocarbon group, and R¹⁰ is derived from a C₆₋₂₀ perfuming alcohol of formula R¹⁰ OH as defined above.

5. The perfuming composition of matter according to claim 1, wherein the at least one profragrance is selected from the group consisting of 4-(dodecylthio)-4-(2,6,6-trimethyl-2-cyclohexen-1-yl)-2-butanone, 4-(dodecylthio)-4-(2,6,6-trimethyl-1-cyclohexen-1-yl)-2-butanone, trans-3-(dodecylthio)-1-(2,6,6-trimethyl-3-cyclohexen-1-yl)-1-butanone, and 3,7-dimethyl-2,6-octadi en-1-yl hexadecanoate.

6. The perfuming composition of matter according to claim 1, wherein the at least one perfuming ingredient having a LogP above 3 is selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{2,6}]undecan-7-one, tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0^{2,6}]dec-3-en-8-yl acetate, tricyclo[5.2.1.0^{2,6}]dec-4-en-8-yl acetate, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, 1-[(1RS,2RS)-1,2,8,8-tetramethyl-1,2,3,4,5,6,7,8-octahydro-2-naphthalenyflethanone, 1-[(1RS,2RS,8aSR)-1,2,8,8-tetramethyl-1,2,3,5,6,7,8,8a-octahydro-2-naphthalenyflethenone, 1-(1,2,3,4,5,6,7,8-octahydro-2,3,8,8,-tetramethyl-2-naphthyl)ethan-1-one, (1-ethoxyethoxy)cyclododecane, (ethoxymethoxy)cyclododecane, cyclohexyl 2-hydroxybenzoate, 2-methylbutyl salicylate, pentyl salicylate, 2-phenylethyl 2-hydroxybenzoate, hexyl 2-hydroxybenzoate, benzyl salicylate, cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, 1-oxa-12-cyclohexadecen-2-one, 1-oxa-13-cyclohexadecen-2-one, (+−)-2-methylundecanal, 2-methyldecanal, (3Z)-3-hexen-1-yl salicylate, (Z)-3-hexen-1-yl benzoate, patchouli oil, (1R,3R,6S,7S,8S)-2,2,6,8-tetramethyltricyclo [5.3.1.0^{3,8}]undecan-3-ol, (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal, (2E)-1-[(1RS,2SR)-2,6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one,limonene, 2,4,4,7-tetramethyl-6,8-nonadien-3-one oxime, 2-(4-methyl-3-cyclohexen-1-yl)-2-propanethiol, 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n43-(1,3-benzodioxo1-5-yl)-2-methyl-1-propenyl]anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7,8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy-3,7-dimethyl-1-octenyl)anthranilate, methyl 2-(methylamino)benzoate, oxacyclohexadecan-2-one, oxacycloheptadecan-2-one, dodecahydro-3a,6,6,9a-tetramethyl-naphtho[2,1-b]furan or any of its stereoisomers, 1,1′-oxydibenzene, 4-methyl-2-phenyltetrahydro-2H-pyran, tetrahydro-4-m ethyl-2-(2-m ethyl-1 -propenyl)-2H-pyran, (+−)-4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran, orange oil, 10-undecenal, 9-undecenal, decanal and a mixture thereof.

7. The perfuming composition of matter according to claim 1, wherein the perfuming composition comprises, as perfuming ingredient having a LogP above 3, at least one compound selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1,6}]undecan-7-one and a mixture thereof at least two compounds selected from the group consisting of tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0^{2,6}]dec-3-en-8-yl acetate, tricyclo[5.2.1.0^{2,6}]dec-4-en-8-yl acetate and a mixture thereof at least three compounds selected from the group consisting of 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, 1-[(1RS,2RS)-1,2,8,8-tetramethyl-1,2,3,4,5,6,7,8-octahydro-2-naphthalenyl]ethanone, 1-[(1RS,2RS,8aSR)-1,2,8,8-tetramethyl-1,2,3,5,6,7,8,8a-octahydro-2-naphthalenyl]ethenone, 1-(1,2,3,4,5,6,7,8-octahydro-2,3,8,8,-tetramethyl-2-naphthyl)ethan-1-one, (i-ethoxyethoxy)cyclododecane, (ethoxymethoxy)cyclododecane and a mixture thereof; at least three compounds selected from the group consisting of cyclohexyl 2-hydroxybenzoate, 2-methylbutyl salicylate, pentyl salicylate, 2-phenylethyl 2-hydroxybenzoate, hexyl 2-hydroxybenzoate, benzyl salicylate, (3Z)-3-hexen-1-yl salicylate, (Z)-3-hexen-1-yl benzoate and a mixture thereof; at least one compound selected from the group consisting of cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, and a mixture thereof; at least one compound selected from the group consisting of (+−)-2-methylundecanal, 2-methyldecanal and a mixture thereof; at least one compound selected from the group consisting of patchouli oil, (1R,3R,6S,7S,8S)-2,2,6,8-tetramethyltricyclo[5.3.1.0^{3,8}]undecan-3-ol and a mixture thereof; at least two compounds selected from the group consisting of (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal and a mixture thereof; at least one compound selected from the group consisting of (2E)-1-[(1RS,2SR)-2,6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one and a mixture thereof; at least two compounds selected from the group consisting of limonene, 2,4,4,7-tetramethyl-6,8-nonadien-3-one oxime, 2-(4-methyl-3-cyclohexen-1-yl)-2-propanethiol, orange oil and a mixture thereof; at least one compound selected from the group consisting of 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n-[3-(1,3-benzodioxol-5-yl)-2-methyl-1-propenyl]anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7,8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy-3,7-dimethyl-1-octenyl)anthranilate, methyl 2-(methylamino)benzoate and a mixture thereof; at least two or three compounds selected from the group consisting of oxacyclohexadecan-2-one, oxacycloheptadecan-2-one, 1-oxa-12-cyclohexadecen-2-one, 1-oxa-13-cyclohexadecen-2-one and a mixture thereof; at least one compound selected from the group consisting of dodecahydro-3a,6,6,9a-tetramethyl-naphtho[2,1-b]furan or any of its stereoisomers and a mixture thereof; at least one compound selected from the group consisting of 1,1′-oxydibenzene, 4-methyl-2-phenyltetrahydro-2H-pyran, tetrahydro-4-methyl-2-(2-methyl-1-propenyl)-2H-pyran, (+−)-4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran and a mixture thereof ; and at least two compounds selected from the group consisting of 10-undecenal, 9-undecenal, decanal and a mixture thereof.

8. A perfuming composition comprising:
i) as perfuming ingredient, a perfuming composition of matter as defined in claim 1;
ii) at least one ingredient selected from the group consisting of a perfumery carrier and a perfumery base; and
iii) optionally at least one perfumery adjuvant.

9. A perfumed consumer product comprising a perfuming composition of matter as defined in claim 1.

10. The perfumed consumer product according to claim 9, characterized in that the perfumery consumer product is a perfume, a fabric care product, a body-care product, a cosmetic preparation, a skin-care product, an air care product or a home care product.

11. The perfumed consumer product according to claim 10, characterized in that the perfumery consumer product is a fine perfume, a splash or eau de parfum, a cologne, a shave or after-shave lotion, a liquid, pod or solid detergent or tablet, a fabric softener, a fabric refresher, a liquid or solid scent booster, a dryer sheet, an ironing water, a paper, a bleach, a carpet cleaner, a curtain—care product, a shampoo, a leave-on or rinse-off hair conditioner, a coloring preparation, a color care product, a hair shaping product, a dental care product, a disinfectant, an intimate care product, a hair spray, a skin cream or lotion, a vanishing cream, a deodorant or antiperspirant, a hair remover, a tanning or sun product, a nail product, a skin cleansing, a makeup, a perfumed soap, a shower or bath mousse, oil or gel, a foot/hand care product, a hygiene product, an air freshener, a “ready to use” powdered air freshener, a mold remover, a furnisher care, a wipe, a dish detergent or a hard-surface detergent, a leather care product, a car care product.

12-13. (canceled)

14. A method for conferring, improving, enhancing or modifying fragrance intensity of the fragrance composition on a skin, surface or in the air surrounding of the skin or the surface over a prolonged period of time, under ambient conditions, wherein the method comprises the step of applying the perfuming composition of matter as defined in claim 1 to a skin, surface or air.

15. A method to confer, enhance, improve or modify the odor properties of a perfuming composition or of a perfumed article, which method comprises adding to said composition or article an effective amount of the perfuming composition of matter as defined in claim 1.

16. The method according to claim 14, wherein the prolonged period of time is at least 72 hours.

17. The perfuming composition of matter according to claim 3, wherein the at least one perfuming ingredient having a LogP above 3 is selected from the group consisting of 2-methyl-3-[4-(2-methyl-2-propanyl)phenyl]propanal, 3-(4-isobutyl-2-methylphenyl)propanal, 9-hydroxy-5,9-dimethyl-4-decenal, 1-(4-isopropyl-1-cyclohexyl)-1-ethanol, 2,2-dimethyl-3-(3-methylphenyl)-1-propanol, 7-hydroxy-3,7-dimethyloctanal, 4-(2-propanyl)cyclohexyl]methanol, 3-(4-methoxyphenyl)-2-methylpropanal, 3-(4-tert-butylphenyl)propanal, 3-(4-isopropylphenyl)-2-methylpropanal, (4E)-4-methyl-5-(4-methylphenyl)-4-pentenal, 3/4-(4-hydroxy-4-methylpentyl)-3-cyclohexene-1-carbaldehyde, tetrahydro-2-isobutyl-4-methyl-4(2H)-pyranol, (2,5-Dimethyl-2,3-dihydro-1H-inden-2-yl)methanol, (+−)-8,8-dimethyl-1,2,3,4,5,6,7,8-octahydro-2-naphthalenecarbaldehyde, (+−)-8,8-dimethyl-1,2,3,5,6,7,8,8a-octahydro-2-naphthalenecarbaldehyde, (+−)-8,8-dimethyl-1,2,3,4,6,7,8,8a-octahydro-2-naphthalenecarbaldehyde, (+−)-2,2-dimethyltricyclo[6.2.1.0^{1,6}]undecan-7-one, tricyclo[5.2.1.0(2,6)]dec-3-en-8-yl propanoate, tricyclo[5.2.1.0(2,6)]dec-4-en-8-yl propanoate, benzyl propanoate, 2-cyclohexylethyl acetate, cyclohexyl acetate, tricyclo[5.2.1.0^{2,6}]dec-3-en-8-yl acetate, tricyclo[5.2.1.0^{2,6}]dec-4-en-8-yl acetate, 1-((2RS,3RS)-2,3,8,8-tetramethyl-1,2,3,4,5,6,7,8-octahydronaphthalen-2-yl)ethanone, 1-[(2RS,3RS,8aRS)-2,3,8,8-tetramethyl-1,2,3,5,6,7,8,8a-octahydro-2-naphthalenyl]ethanone, 1-[(2RS,3RS,8aRS)-2,3,8,8-tetramethyl-1,2,3,4,6,7,8,8a-octahydro-2-naphthalenyl]ethanone, 1-[(1RS,2RS)-1,2,8,8-tetramethyl-1,2,3,4,5,6,7,8-octahydro-2-naphthalenyl]ethanone, 1-[(1RS,2RS,8aSR)-1,2,8,8-tetramethyl-1,2,3,5,6,7,8,8a-octahydro-2-naphthalenyflethenone, 1-(1,2,3,4,5,6,7,8-octahydro-2,3,8,8,-tetramethyl-2-naphthyl)ethan-1-one, (1-ethoxyethoxy)cyclododecane, (ethoxymethoxy)cyclododecane, cyclohexyl 2-hydroxybenzoate, 2-methylbutyl salicylate, pentyl salicylate, 2-phenylethyl 2-hydroxybenzoate, hexyl 2-hydroxybenzoate, benzyl salicylate, cyclohexylidene(phenyl)acetonitrile, dodecanenitrile, 3,7-dimethyl-6-octenenitrile, 2,6-nonadienenitrile, 2-tridecenenitrile, 3-tridecenenitrile 3,7-dimethyl-2,6-nonadienenitrile, 2-phenyl-2-hexenenitrile, 3,12-tridecadienenitrile, 3-methyl-5-phenyl-2-pentenenitrile, 2-methyldecanenitrile, 1-oxa-12-cyclohexadecen-2-one, 1-oxa-13-cyclohexadecen-2-one, (+−)-2-methylundecanal, 2-methyldecanal, (3Z)-3-hexen-1-yl salicylate, (Z)-3-hexen-1-yl benzoate, patchouli oil, (1R,3R,6S,7S,8S)-2,2,6,8-tetramethyltricyclo[5.3.1.0^{3,8}]undecan-3-ol, (+−)-3-(4-methyl-3-penten-1-yl)-3-cyclohexene-1-carbaldehyde, (+−)-4-(4-methyl-3-penten-1-yl)-3-cyclohexene-1-carbaldehyde, 3-methyl-5-phenylpentanal, 4-decenal, 2-decenal, (2E)-1-[(1RS,2SR)-2,6,6-trimethyl-3-cyclohexen-1-yl]-2-buten-1-one, 1-(2,6,6-trimethyl-2-cyclohexen-1-yl)-2-buten-1-one, 1-(2,6,6-trimethyl-1-cyclohexen-1-yl)-2-buten-1-one, 1-(2,4,4-trimethyl-2-cyclohexen-1-yl)-2-buten-1-one, 1-(2,4,4-trimethyl-1-cyclohexen-1-yl)-2-buten-1-one, 1-(2,2-dimethyl-6-methylenecyclohexyl)-2-buten-1-one,limonene, 2,4,4,7-tetramethyl-6,8-nonadien-3-one oxime, 2-(4-methyl-3-cyclohexen-1-yl)-2-propanethiol, 2-methoxynaphthalene, methyl n-(2-hexyl-3-phenyl-2-propenylidene)anthranilate, methyl n-(3,5,5-trimethylhexylidene)anthranilate, methyl 2-((2,4-dimethylcyclohex-3-enylidene)methylamino)benzoate, methyl n-(1-octenyl)anthranilate, methyl n-(4-methoxybenzylidene)anthranilate, methyl n-[3-(4-tert-butylphenyl)-2-methyl-1-propenyl]anthranilate, methyl 2-({[3/4-(4-hydroxy-4-methylpentyl)-3-cyclohexen-1-ylidene]methyl}amino)benzoate, methyl n-benzylideneanthranilate, methyl n-(2-phenylethylidene)anthranilate, methyl n43-(1,3-benzodioxo1-5-yl)-2-methyl-1-propenyl]anthranilate, methyl n-[2-(4-methoxybenzyl)-1-propenyl]anthranilate, methyl n-(7-hydroxy-3,7-dimethyl-1-octenyl)anthranilate, methyl 2-(((E)-3-phenylallylidene)amino)benzoate, methyl 2-(decylideneamino)benzoate, methyl [3/4-(4-hydroxy-4-methylpentyl)-3-cyclohexen-1-yl]methyleneanthranilate, methyl 2-[(7-hydroxy-3,7-dimethyloctylidene)amino]benzoate, methyl (3S)-n-(7-hydroxy-3,7-dimethyloctylidene)anthranilate, methyl n-[2-(4-methoxybenzyl)propylidene]anthranilate, ethyl 2-{[(2,4/3,5-dimethyl-3-cyclohexen-1-yl)methyl]amino}benzoate, ethyl 2-{[(1E)-(4-tert-butylphenyl)methylene]amino}benzoate, methyl n-(octylidene)anthranilate, methyl n-[3-(p-tert-butylphenyl)-2-methylpropylidene]anthranilate, methyl n-[3-(4-isopropyl-1-phenyl)-2-methylpropylidene]anthranilate, 2-ethoxynaphthalene, 1-(5,6,7,8-tetrahydro-2-naphthalenyl)ethanone, 1-(3-methyl-1-benzofuran-2-yl)ethanone, 1-(1-naphthyl)ethanone, 1-(2-naphthyl)ethanone, methyl 2-aminobenzoate, methyl n-(7-hydroxy-3,7-dimethyl-1-octenyl)anthranilate, methyl 2-(methylamino)benzoate, oxacyclohexadecan-2-one, oxacycloheptadecan-2-one, dodecahydro-3a,6,6,9a-tetramethyl-naphtho[2,1-b]furan or any of its stereoisomers, 1,1′-oxydibenzene, 4-methyl-2-phenyltetrahydro-2H-pyran, tetrahydro-4-methyl-2-(2-methyl-1-propenyl)-2H-pyran, (+−)-4-methylene-2-phenyltetrahydro-2H-pyran, (+−)-4-methyl-6-phenyl-3,6-dihydro-2H-pyran, (+−)-4-methyl-2-phenyl-3,6-dihydro-2H-pyran, orange oil, 10-undecenal, 9-undecenal, decanal and a mixture thereof

18. A perfuming composition comprising:
i) as perfuming ingredient, a perfuming composition of matter as defined in claim 17;
ii) at least one ingredient selected from the group consisting of a perfumery carrier and a perfumery base; and
iii) optionally at least one perfumery adjuvant.

19. A perfumed consumer product comprising a perfuming composition of matter as defined in claim 17.

20. The perfumed consumer product according to claim 19, characterized in that the perfumery consumer product is a perfume, a fabric care product, a body-care product, a cosmetic preparation, a skin-care product, an air care product or a home care product.

21. A method for conferring, improving, enhancing or modifying fragrance intensity of the fragrance composition on a skin, surface or in the air surrounding of the skin or the surface over a period of time of more than 72 hours, under ambient conditions, wherein the method comprises the step of applying the perfuming composition of matter as defined in claim 17 to a skin, surface or air.

22. A method to confer, enhance, improve or modify the odor properties of a perfuming composition or of a perfumed article, which method comprises adding to said composition or article an effective amount of the perfuming composition of matter as defined in claim 17.
